(19) United States
(12) Patent Application Publication
(10) Pub. No.: US 2016/0343001 A1
(43) Pub. Date: Nov. 24, 2016

(54) MULTI-CHANNEL CUSTOMER SUPPORT AND SERVICE

(71) Applicant: Apple Inc., Cupertino, CA (US)

(72) Inventors: Mary Jane Hawes, Portola Valley, CA (US); James Lee Burdine, Austin, TX (US); Michael Lawder, Austin, TX (US); Edward Pierce, Austin, TX (US)

(21) Appl. No.: 15/231,509

(22) Filed: Aug. 8, 2016

Related U.S. Application Data
(63) Continuation of application No. 13/589,036, filed on Aug. 17, 2012.

(51) Int. Cl. G06Q 30/00; G06F 3/0482

(52) U.S. Cl. CPC G06Q 30/016; G06F 3/0482

(57) ABSTRACT

Disclosed herein are systems, methods, and non-transitory computer-readable storage media for providing service and support solutions to a user device. A system is described that provides user centric solution system by connecting a user device to multiple solution channels. This includes receiving symptom information from the user device and combining that information along with diagnostic information from the product to identify the problem. The system can also provide solution options to the user based on the availability of each support channel and the products' or services entitlements and support policies.

This application is a continuing application of U.S. Non-provisional patent application Ser. No. 13/589,036, entitled “MULTI-CHANNEL CUSTOMER SUPPORT AND SERVICE” and filed Aug. 17, 2012, the contents of which are herein incorporated by reference in their entirety as if fully set forth herein.

### BACKGROUND

1. Technical Field

The present disclosure relates generally to technical support, and more specifically to improved techniques for providing multi-channel support and services to customers.

2. Introduction

Technical support is provided by companies to assist users in troubleshooting issues with goods or services sold by the company. Traditional methods of technical support have included phone, email, chat and carry-in support. One or more of these support channels are made available to the user who can in turn choose the support channel that is most convenient for the user.

A user can call a toll free customer service number to speak with a customer service representative. The representative can provide technical support and recommend potential solutions to the problem. However, the solutions suggested do not always satisfactorily solve the issue and the wait times to speak with the representative can vary. Alternatively, the user can email customer service and wait for a response from a service representative. After a few days pass, the service representative emails a response to the user. Since the communication between the two parties is not an active one, it can sometimes take a few iterations of emailing back and forth before a satisfactory solution is found. This can sometimes take weeks and thus does not provide a timely resolution. Alternatively, the user can also carry in the product to a brick and mortar store for repair. Technical service representatives or other staff at the store can assist the user in troubleshooting the issue. However, this is inconvenient and time consuming since the user has to travel to the store, especially for something that could have been solved over the phone or via email.

A user can choose one of the available support channels to find a solution. If the support channel does not resolve the user's issues, another channel can be chosen. However, the user generally has to re-describe the issue as the user goes through the process of the other support channel since there is limited data sharing and intelligence between the different support channels. Thus, there is a need for improved techniques for providing technical support and services to customers.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for responding to customer assistance requests received from a user device. The customer requests include assistance on how to use a product, shipping status of a product, a purchase request, a service request, and a support request. The solutions recommended can be based on diagnostics of the issue, the solutions' availability, and also the entitlements (e.g., types of warranty coverage) that the product has. A system is described that provides a user centric solution that allows a user to have access to multiple solution channels through a single portal. Moreover, the solution options presented to the user take into consideration factors such as the availability of each solution channel, the product's eligibility for each support, and the diagnosis of the product. In some examples, the user can communicate with the system to diagnose an issue with the product or offer certain solutions based on an issue.

During the diagnosis, a determination is made that retrieving diagnostic information from the product can be useful for diagnosing the issue. The system can communicate with the user device to receive device information associated with the product. The contact information can be utilized by the system to retrieve the diagnostic information from the product. Once the diagnostic information is retrieved, the system can try to identify a potential problem based on feedback received from the user, diagnostic information received from the device, metadata transmitted with the request, and then provide that information to authorized solution providers. Afterwards, the system can determine one or more solutions from the available solutions that can be presented to the user as solution options. The solution options presented to the user can depend on the availability of the solutions, the warranty coverage of the product, the system's ability to accurately identify the problem, the locale and time of day, customer location, the product, the symptom, specific product purchased, real-time resource availability, real-time service level performance questions answered by the customer, and other rules. The solutions presented to the user can change dynamically based on real-time changes to the availability and performance of the solution channels.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary system embodiment;

FIG. 2 illustrates an exemplary cloud computing system;

FIG. 3 illustrates an exemplary multi-channel solutions system;

FIG. 4 illustrates an exemplary process of deep linking in the symptoms engine;

FIG. 5 illustrates an exemplary screen shot of deep linking;

FIG. 6 illustrates an exemplary welcome page;

FIG. 7 illustrates an exemplary user sign in prompt;

FIG. 8 illustrates an exemplary products page;

FIG. 9 illustrates an exemplary topics page;

FIGS. 10A-C illustrate an exemplary pop up user interface configured to request diagnostic information;

FIG. 11 illustrates an exemplary solutions page;

FIG. 12 illustrates an exemplary user interface to inform the user of a change in the solution options presented;

FIG. 13 illustrates an exemplary support solution page;

FIG. 14 illustrates an exemplary service solution page;

FIG. 15 illustrates another exemplary service solution page;

FIG. 16 illustrates an exemplary process for providing support and service solutions for a product; and

FIG. 17 illustrates another exemplary process for providing support and service solutions.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The present disclosure addresses the need in the art for systems, techniques, and methods for responding to customer requests for assistance. The customer assistance requests can include assistance on how to use a product, shipping status of a product, a purchase request, a service request (e.g., product needs repair), and a support request (e.g., troubleshoot issue with the product), to name a few. A customer assistance request can be analyzed and routed to one of multiple solution channels configured to process the request. Different types of solutions can be provided depending on the solution channel the customer assistance request is routed to. This offers the customer a variety of solutions through a single point of contact. The solution channels can include self-help solutions (e.g., articles and community), live support solutions (e.g., call, chat, email, in store), and repair solutions (e.g., self-repair, mail-in repair and carry-in repair). Depending on factors such as the user's response to questions provided by the system, the user's entitlements, and the solution resources available, the system can use heuristics to try to narrow the customer's assistance request to a specific category, topic, or problem and recommend solutions that are applicable to the category or problem. In some examples, the system can retrieve diagnostic information from the product in question to better analyze the customer assistance request. This can also result in the discovery of other problems with the product that the user is unaware of.

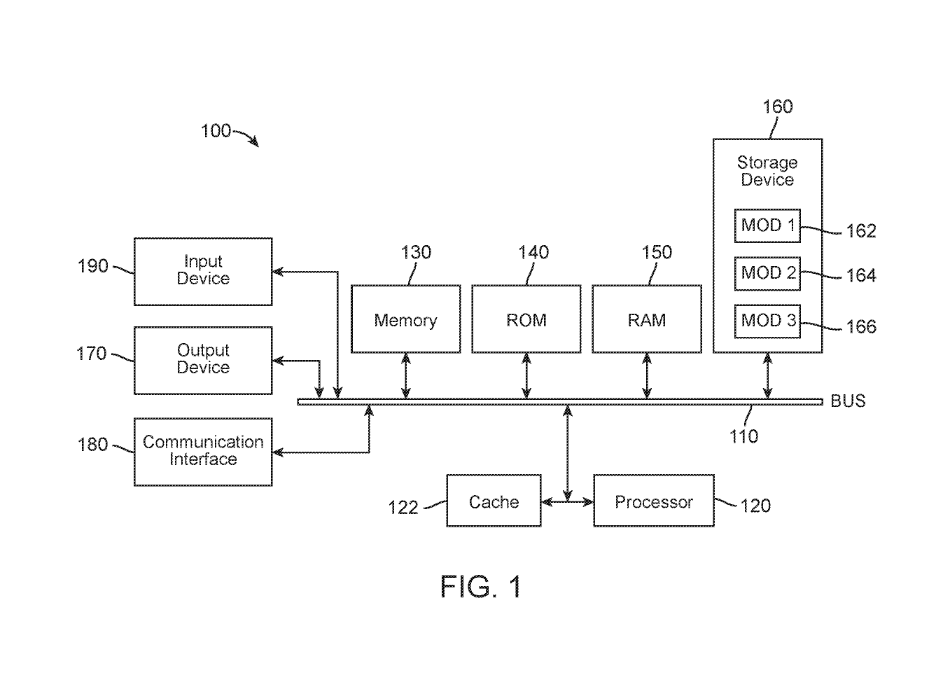

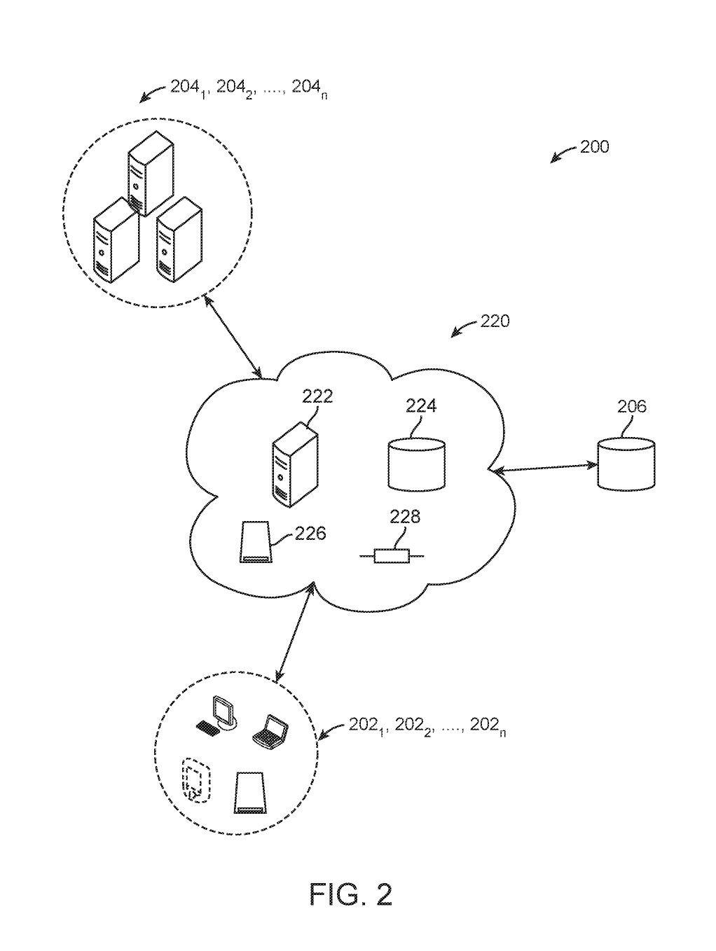

A detailed discussion of the methods and systems surrounding the concept of providing various forms of support and services to a user or customer via a single point of contact is described below. First, a brief introductory description of a basic general purpose system or computing device which can be employed to practice the concepts is illustrated in FIG. 1. This is followed by an introductory description of a cloud computing system in FIG. 2. The disclosure now turns to FIG. 1.

### General System

With reference to FIG. 1, an exemplary system 100 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, a solid state drive, a tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

Having disclosed some components of a computing system, the disclosure now turns to techniques and systems for gifting digital media items.

### Cloud Computing System

Cloud computing is a type of Internet-based computing in which a variety of resources are hosted and/or controlled by an entity (that may be distributed) that is accessible via the Internet and made available by the entity to authorized users via the Internet. An exemplary cloud computing system configuration 200 is illustrated in FIG. 2 wherein a variety of electronic devices can communicate via a network for purposes of exchanging content and other data. The system can be configured for use on a wide variety of network configurations that facilitate the intercommunication of electronic devices. For example, each of the components of system 200 in FIG. 2 can be implemented in a localized or distributed fashion in a network.

System 200 can be configured to include cloud computing resources 220 (i.e., “the cloud”). The cloud resources can include a variety of hardware and/or software resources, such as cloud servers 222, cloud databases 224, cloud storage 226, cloud networks 228, cloud applications, cloud platforms, and/or any other cloud-based resources. In some cases, the cloud resources are distributed. For example, cloud storage 226 can include multiple storage devices. In some cases, cloud resources can be distributed across multiple cloud computing systems and/or individual network enabled computing devices. For example, cloud computing resources 220 can communicate with servers 204₁, 204₂, . . . , 204ₙ (collectively “204”), database 206, and/or any other network enabled computing device to provide the cloud resources.

Furthermore, in some cases, the cloud resources can be redundant. For example, if cloud computing resources 220 are configured to provide data backup services, multiple copies of the data can be stored such that the data is still be available to the user even if a storage resource is offline, busy, or otherwise unavailable to process a request. In another example, if cloud computing resources 220 is configured to provide software, the software can be available from different cloud servers so that the software can be served from any of the different cloud servers. Algorithms can be applied such that the selection criteria such as the closest server, the server with the lowest current load, or other selection criteria, etc. is used to select a server to process a given request.

In system 200, a user interacts with cloud computing resources 220 through user terminals 202₁, 202₂, . . . , 202ₙ (collectively “202”) connected to a network by direct and/or indirect communication. Cloud computing resources 220 can support connections from a variety of different electronic devices, such as servers; desktop computers; mobile computers; handheld communications devices, e.g., mobile phones, smart phones, tablets; set top boxes; network-enabled hard drives; and/or any other network-enabled computing devices. Furthermore, cloud computing resources 220 can concurrently accept connections from and interact with multiple electronic devices. Interaction with the multiple electronic devices can be prioritized or occur simultaneously.

Cloud computing resources 220 can provide cloud resources through a variety of deployment models, such as public, private, community, hybrid, and/or any other cloud deployment model. In some cases, cloud computing resources 220 can support multiple deployment models. For example, cloud computing resources 220 can provide one set of resources through a public deployment model and another set of resources through a private deployment model.

In some configurations, a user terminal 202 can access cloud computing resources 220 from any location where an Internet connection is available. However, in other cases, cloud computing resources 220 can be configured to restrict access to certain resources such that a resource can only be accessed from certain locations. For example, if cloud computing resources 220 are configured to provide a resource using a private deployment model, then cloud computing resources 220 can restrict access to the resource, such as by requiring that a user terminal 202 access the resource from behind a firewall.

Cloud computing resources 220 can provide cloud resources to user terminals 202 through a variety of service models, such as Software as a Service (SaaS), Platforms as a service (PaaS), Infrastructure as a Service (IaaS), and/or any other cloud service models. In some cases, cloud computing resources 220 can provide multiple service models to a user terminal 202. For example, cloud computing resources 220 can provide both SaaS and IaaS to a user terminal 202. In some cases, cloud computing resources 220 can provide different service models to different user terminals 202. For example, cloud computing resources 220 can provide SaaS to user terminal 202₁ and PaaS to user terminal 202₂.

In some cases, cloud computing resources 220 can maintain an account database. The account database can store profile information for registered users. The profile information can include resource access rights, such as software the user is permitted to use, maximum storage space, etc. The profile information can also include usage information, such as computing resources consumed, data storage location, security settings, personal configuration settings, etc. In some cases, the account database can reside on a database or server remote to cloud computing resources 220 such as servers 204 or database 206.

Cloud computing resources 220 can provide a variety of functionality that requires user interaction. Accordingly, a user interface (UI) can be provided for communicating with cloud computing resources 220 and/or performing tasks associated with the cloud resources. The UI can be accessed via an end user terminal 202 in communication with cloud computing resources 220. The UI can be configured to operate in a variety of client modes, including a fat client mode, a thin client mode, or a hybrid client mode, depending on the storage and processing capabilities of cloud computing resources 220 and/or the user terminal 202. Therefore, a UI can be implemented as a standalone application operating at the user terminal in some embodiments. In other embodiments, a web browser-based portal can be used to provide the UI. Any other configuration to access cloud computing resources 220 can also be used in the various embodiments.

As described above, in some configurations, the cloud computing resources can be used to store user data. The present disclosure contemplates that, in some instances, this gathered data might include personal and/or sensitive data. The present disclosure further contemplates that the entities responsible for the collection, analysis, disclosure, transfer, storage, or other use of such data should implement and consistently use privacy policies and practices that are generally recognized meeting or exceeding industry or governmental requirements for maintaining personal information data private and secure. For example, personal data from users should be collected for legitimate and reasonable uses of the entity and not shared or sold outside of those legitimate uses. Further, such collection should occur only after the informed consent of the users. Additionally, such entities should take any needed steps for safeguarding and securing access to such personal data and ensuring that others with access to the personal data adhere to their privacy and security policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal data. That is, the present disclosure contemplates that hardware and/or software elements can be provided to prevent or block access to such personal data. For example, the present technology can be configured to allow users to select the data that is stored in cloud storage. In another example, the present technology can also be configured to allow a user to specify the data stored in cloud storage that can be shared with other users.

Therefore, although the present disclosure broadly covers use of personal data to implement one or more various disclosed embodiments, the present disclosure also contemplates that the various embodiments can also be implemented without the need for accessing such personal data. That is, the various embodiments of the present technology are not rendered inoperable due to the lack of all or a portion of such personal data. For example, non-personal data can be stored in cloud storage.

### The Multi-Channel Solutions System

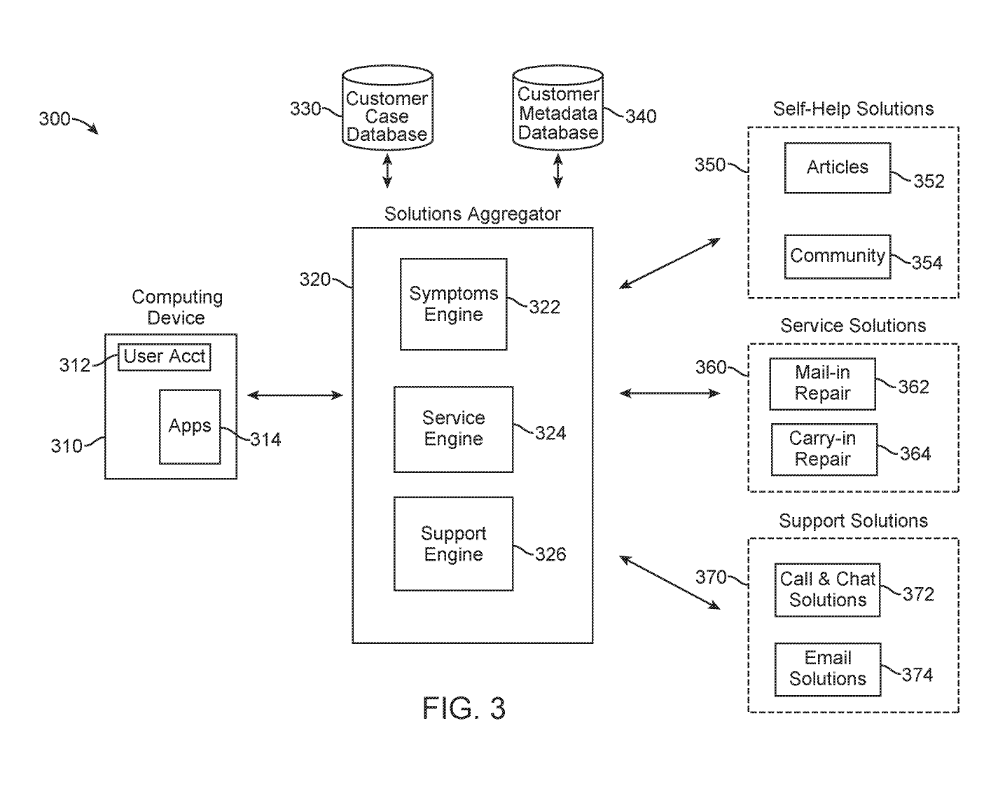

FIG. 3 illustrates an exemplary multi-channel solutions system. As shown, system 300 includes computing device 310, solutions aggregator 320, customer case database 330, customer metadata database 340, self-help solutions 350, service solutions 360, and support solution options 370. While the discussion below describes the solutions system providing solutions to a customer operating computing device 310, the solutions system can also provide solutions to users of computing device 310 that are not customers. For example, a computing device belonging to a school is loaned out to a student to use during the school year. Although the student did not purchase the device and thus is not a customer, the student can still utilize the solutions system. The solutions system can be provided by the manufacturer, seller, or other entity that belongs to the sales chain.

Computing device 310, which can include one or more components illustrated in exemplary computing device of FIG. 1 and used in an operating environment such as FIG. 2, can be configured to communicate with solutions aggregator 320. The communications can include a customer assistance request related to a product or service that is supported by system 300. While the discussion of the multi-channel solutions system below will focus on a product supported by system 300, it is to be understood that these discussions can also be extended to services supported by system 300. The communications can also include communicating back and forth with solutions aggregator 320 to analyze the customer assistance request for determining solution channels that are most appropriate given the assistance request. If the customer assistance request is a request for product support or service, the communications can analyze the issue with the product (or service) in hopes of identifying a specific problem with the product (or service). The product (or service) can be implemented in hardware or software.

In one embodiment, the customer assistance request can be to address an issue on computing device 310. For example, the issue can be with application 314. In another example, the issue can be with hardware of computing device 310. In other embodiments, the customer assistance request can be related to a product (or service) not associated with computing device 310. For example, the customer can run into an issue while operating another electronic device that does not have the means to communicate with solutions aggregator 320. Upon discovering an issue with the another electronic device, the customer can use a web browser application or other application running on computing device 310 to initiate a customer assistance request with solutions aggregator 320 for the another electronic device. Computing device 310 may contain account information credentials (user account 312) and pass this information to solutions aggregator 320 to identify the customer operating computing device 310. User account information can be utilized by solutions aggregator to look up the products that are associated with the given user account and also the entitlements of those products. Entitlements may include services and support solutions that the product is entitled to and the expiration date, if any, of these solutions. For example, the warranty associated with the customer's smart phone may still be valid another year while the warranty associated with the customer's laptop may have already expired. The warranty status of the product can affect the solution options that are presented to the customer. In some examples, offers to purchase entitlements can be presented for solution options that the product is not entitled to.

Solutions aggregator 320 is configured to analyze a customer assistance request with a product (or service) and route the customer assistance request to a solution channel capable of processing the request. In some examples, one or more solution options (e.g., self-help solutions 350, service solutions 360, support solution options 370) can be presented to the customer and the customer can select a preferred solution option. Solutions aggregator 320 can route the customer assistance request to a solution provider configured to process the customer's preferred solution option. For example, support providers can handle support solutions while service providers can handle service solutions. Each provider can include a set of rules to manage and process the queue of customer's seeking assistance. The solution options presented to the customer can depend on factors including the product or service specified, device making the request, type of issue, diagnosis of the issue, the date and time of the request, the point of purchase for the product, the entitlements of the customer or the product, the available resource bandwidth of the solution provider, the language of the customer, the location of the product, available spoken or written languages of the solution provider, the hours of operation of the solution provider, and others. These factors can be processed by a heuristics engine which returns a list of solution options that are able to process the customer assistance request and sometimes, a recommended solution option.

In one embodiment, a customer can report an issue with a product (or service) by using a web browser application or other application to transmit an assistance request for the issue to solutions aggregator 320. For example, a customer can select a help link in an application running on the client device to request assistance. In another embodiment, an assistance request for an issue with a product (or service) can be automatically generated by computing device 310. For example, computing device 310 can automatically transmit a request to solutions aggregator 320 when a product running on computing device 310 suffers from an error, problem, or issue. Exemplary scenarios include a fatal error occurring on an application running on computing device 310 or a component of computing device 310 overheating. The overheating can cause a monitoring application to generating a warning and transmit a request to solutions aggregator 320 for service. Regardless of how the request is generated, solutions aggregator 320 can start a support session between solutions aggregator 320 and computing device 310 in response to the request. The support session can include communicating back and forth between computing device 310 and solutions aggregator 320 to diagnose the request and apply heuristics to identify the one or more solution options capable of processing the request. The type of communications that takes place during a support session can depend on the type of request, the symptom engine 322's ability to analyze the request, the severity of an issue that the request is attempting to have addressed, and others. In some examples, the request can include metadata (such as a crash log) that is associated with the problem. The metadata can provide the solutions aggregator 320 and downstream support resources some context to the problem, thus shortening the support session. Information acquired during the support session can be stored in customer case database 330 and/or customer metadata database 340 to be used by downstream support resources, including the solution providers.

Solutions aggregator 320 can interpret all the information acquired during the support session to narrow the customer's question or issue to a specific category or problem. Solutions aggregator 320 can then determine the solutions that are configured to or are best suited to help the customer resolve their question or issue based on pre-defined rule sets. This input analysis can take a look at multiple factors, such as the locale and time of day that the customer is requesting help, the business hours of the each solution offering, entitlement information describing the types of support that the product or user is entitled to, and scheduling information for each solution. This information is gathered to identify and present the most appropriate, ranked solutions for the customer's interactive support session. Solutions aggregator 320 can also recommend a particular solution that is best suited to the customer's problem, based on the entitlement information and/or the problem identified. Thus, solutions aggregator 320 can provide customers a variety of ranked solutions, including self-help, support, and service options for a question or issue with a product through a single point of contact. The solutions can include articles to assist the customer in resolving their issue themselves, support solutions via email/messaging/voice/chat, or service solutions such as repair requests. Therefore, the customer may be given access to a plethora of ranked solutions while only needing to provide the product and symptom information once. For example, solution options such as a mail-in repair, an online chat, and a telephone call with technical support can all be offered through a single point of contact such as a web page. This is advantageous over traditional methods where each solution has a different point of contact and is restricted to offer solutions by product only. To speak with a technical specialist, the customer dials a number on the phone. To look for self-help solutions, the customer visits a website via a browser on the customer's phone or computer. To schedule a repair, the customer visits another web page.

Solutions aggregator 320 includes symptoms engine 322. Symptoms engine 322 is configured to use heuristics to narrow the customer's assistance request to a specific category, topic, or problem. This can be accomplished by using symptom information describing the question or issue. The symptom information can be received by symptoms engine 322 from a variety of sources including computing device 310, application 314, an inbound URL with metadata, and the support providers. The symptoms information can be used by symptoms engine 322 to identify categories, topics, or topics that are related to the customer's assistance request.

In one embodiment, the symptoms information can include the customer assistance request. The customer assistance request can contain metadata related to the customer's question or issue. For example, the metadata can include customer entered symptoms. In some examples, customer entered symptoms can be tracked and statistics can generated to identify the most common problems or issues that customers are encountering. These common problems can be used as suggestion to help the customer describe the issue with the product or service. In another embodiment, the symptom information can include feedback received from computing device 310 or application 314. The feedback can responses received to questions presented by symptoms engine 322 during the support session. In yet another embodiment, the symptoms information can include data provided from the support providers. For example, a solutions provider can redirect a customer back to solutions aggregator 320 when the solution provider is unable to provide a satisfactory solution to the customer. When the customer is redirected, the solutions provider can include any new information related to the question or issue to solutions aggregator 320. As another example, solutions providers can provide data associated with common symptoms and issues that are processed by each solution provider to solutions aggregator 320. Solutions aggregator 320 can aggregate that data (possibly along with symptoms commonly entered by the customer) to determine the most frequent symptoms and issues. These symptoms and issues can be tagged as popular symptoms and issues. Popular symptoms and issues can be suggested to the customer to assist the customer in describing the issue he or she is having. In yet another embodiment, the symptom information can include data from customer case database 330 or customer metadata database 340. For example, a crash log from computing device 310 that is stored in customer case database 330 can also be used by the symptom engine 322 to analyze the customer's assistance request. Based on the symptom information received, symptoms engine 322 can suggest common categories and topics to identify an issue or question with a product or service.

In another embodiment, symptom information can be incrementally received from the customer through a series of questions that can are created to hierarchically narrow (e.g., product/service→high level topic→detailed issue or customer entered issue) the issue to a specific category, topic, or problem. Based on the customer's answer to a question, other questions can be presented. The questions can be arranged in a decision tree, where traversing the decision tree presents new questions to the customer at each node until a specific support category, topic, or problem is identified. The questions can be organized into pages. For example, a welcome page can be presented first so that the customer can select the product that has an issue. After the customer selects the product, a topic page can be presented that lists possible categories for the product. After a specific category is selected, more specific topics are presented. Once a topic is selected, one or more questions or pages can be presented to the customer to further narrow down the topic or issue until symptoms engine 322 has completed its analysis. In some examples, symptoms engine 322 can support deep linking, which allows a customer to enter the decision tree somewhere in the middle (i.e., warm entry) instead of at the root of the decision tree (i.e., cold entry) by using data that has already been collected by connected systems and delivered in metadata. Where the customer enters the decision tree can depend on the metadata that is submitted along with the request, the customer entered symptoms, aggregated data from support channels, and product taxonomy.

Periodically, the decision tree can be restructured or regenerated to more efficiently handle customer assistance requests. In one embodiment, the restructure can be based on symptom information received over a period of time. For example, the decision tree can be restructured to better address the category, topic, or problem that occurs most often. Since assistance requests are often analyzed to be that category, topic, or problem, the decision tree can be optimized for this. As another example, the decision tree can be optimized for popular customer entered symptoms. In another embodiment, the decision tree can be optimized by product taxonomy. In yet other embodiments, the decision tree can be dynamically rendered based on a selected product taxonomy or customer entered symptom.

In some embodiments, the symptom information can be organized in varying levels of detail (e.g., product/service→high level topic→detailed issue or customer entered issue) as a diagnostic tree. Symptoms engine 322 can use information at each level of this diagnostic tree to identify relevant solutions, structure a request for assistance, store the request for assistance in the customer case database 330, and allow solution providers to see that information in near real-time or in advance of the customer interaction.

The solution to the question or issue presented can come via service engine 324 and support engine 326. Each of these solution engines is capable of providing one or more solutions to address the customer's question or issue. Solutions aggregator 320 aggregates the solutions that fit certain criteria to present ranked solutions to the customer in a user-centric manner. The process of aggregating and offering solutions can include solutions aggregator 320 receiving business rules from each solution provider. The business rules contain rules configured to define the conditions describing the support session that need to be met before solutions are to be provided. For example, the rules can specify the business hours of a solution offering, current performance at the business solution provider (e.g., service levels) and the problems that can be addressed by the solution provider. If the request is related to a problem that can be addressed by the solution provider and is received during the business hours, these conditions have been met. In some examples, different rules can be defined for each geographical location. For example, the business rules can include a set of rules for requests originating from the United States and another set of rules for requests originating from Europe.

The solutions aggregator 320 can apply the business rules to the current request and determine if this solution provider can be a solution option. This allows system 300 to provide the customer a variety of support options from a single troubleshooting session. In another example, solutions aggregator 320 is also configured to transmit data describing the customer's problem to the one or more solution providers. For example, symptoms information gathered by solutions aggregator 320 can be stored in a customer case database 330 as a uniquely identifiable case record. The uniquely identifiable case record can store a request for assistance that is structured in a format that can be easily ingested by the solution providers. As another example, metadata associated with the customer such as the serial number of products belonging to the customer or a list of the customer's products can be stored in customer metadata database 340. This information can be shared with other solution providers so that the customer can smoothly transition to the solution providers without having to resubmit personal information or provide the symptoms again. Thus, providing a description of the issue once allows the customer to receive multiple options for solutions. This is an improvement over traditional methods where a description of the issue needs to be provided each time the customer chooses to use a different solution channel. The user selects the solution channel that he or she would like to use from the recommended solutions.

Here, solutions aggregator 320 is configured to communicate with different types of solution providers, such as self-help solutions 350, repair solutions 360, and support solution options 370. Self-help solutions are solutions that can be provided to customers without requiring human resources from system 300 or its business affiliates. For example, self-help solutions include articles 352 and community 354. Articles 352 can include a database of articles and self-help documents for troubleshooting problems with the customer's product. An article or document that is relevant to the customer's problem can be returned and recommended as the best solution to the customer. Alternatively, an article or document can be returned to the customer in response to answers received from a series of questions designed to diagnose problems with the product. The answers to the series of questions can guide the customer through a decision tree that potentially ends with an article or document that addresses the customer's problem. Community 354 can include an online forum or community with members that are able to offer suggestions or solutions to the customer's problem. Through the community, a member who has experience dealing with the same or similar issue can recommend a solution for the customer, thus allowing human resources of a solutions provider to be reserved for addressing other problems or to provide solutions for customers who are not eligible to obtain assistance without payment to business. In some examples, solutions aggregator 320 recommends self-help solutions over assisted solutions (discussed below) since the self-help solutions do not require business or affiliated human resources and thus are theoretically always available and not constrained by support/service eligibility. Furthermore, less stress is placed on the available human resources, especially if solutions aggregator 320 can point the customer to a technical article that is directly on point with the customer's issue. For instance, solutions aggregator 320 may recommend articles 352 over other solutions if an article exists that directly relates to the diagnosed problem. Solutions aggregator 320 can make this determination of whether such an article exists.

Service solutions 360, which are solutions that involve repairing the product, include mail-in repair 362 and carry-in repair 364. In some examples, mail-in repairs and carry-in repairs can be handled by the same system or CPU. In other examples, the services can be handled by different processors. Mail-in repair 362 can process customer requests to mail in a product for repair. Processing can include arranging pick up of the package, whether the product will be repaired or replaced, and payment information. Processing can also include selecting a courier service, a shipping address, and other shipping information. It can be facilitated via assisted support on a call or in some cases by continuing through the system to make the request online. In contrast, carry-in repair 364 can process customer requests to carry in a product into a physical location for repair. This can include setting up a physical location the product is to be dropped off at (such as a store operated by the manufacturer or a third party repair service), a time for the drop off, payment information for the repair or replacement (if any), and other repair information. Service solutions 360 are assisted solutions since resources (human and/or physical) are expended to repair or replace the products. Assisted solutions may not be available to the customer due to limitations of the solution provider. Moreover, service strategies, logistics and shipping conditions can vary by location. For example, carry-in repair 362 can have a queue develop for customer products that need repair during periods of high demand. This can happen during the holidays or any occasion when the number of customers seeking repair outnumbers the available resources. When a solution provider might not have adequate bandwidth to handle additional service requests, solutions aggregator 320 may not present the option for carry-in repair 362 to the customer during peak periods or might recommend an alternate solution provider. Alternatively in periods of high demand, solutions aggregator 320 can offer the customer the opportunity to schedule a time in the future to carry-in the product for repair. Schedule information describing the future availability of a solution provider can be shared with solutions aggregator 320. The schedule information can be processed by solutions aggregator 320 and provided to computing device 310 as real-time information to schedule a service appointment now or in the future at one or many locations.

Support solution options 370 describe additional assisted support solutions. Assisted support solutions are dynamic solutions where the customer communicates back and forth with a human resource (e.g., technical service representative, customer service representative, retail store representative etc.) to try to resolve the problem. The availability of an assisted support solution can be based on the human resources available at a given point in time. For example if 10 service representatives are available to handle call & chat solution options 372, that solution provider can at most support 10 customers at one time. Any additional customer seeking support can be placed in a queue for the next available service representative. If the queue grows to be larger than a predefined limit or the wait time grows to be longer than a predefined acceptable wait time, solutions aggregator 320 can choose to not offer the chat & solutions support option to the customer. Alternatively, solutions aggregator 320 can also receive the schedule of call & chat solution options 372 and allow a customer to make an appointment to speak with a customer service representative. Scheduling and availability issues can be dealt similarly with email and retail solutions 374. Support solution options 370 include call & chat solution options 372 retail and email solutions 374. Call & chat solution options 372 can include click to call, scheduled callback, call later and save support request for future use, click to chat, and chat later to save support request for future use. Email solution options 372 can include email correspondence between the customer and a service representative.

The solution provider options (e.g., providers of articles 352, community 354, mail-in repair 362, carry-in repair 364, call & chat solution options 372, and email solution options 374) can periodically communicate with solutions aggregator 320 to update the solutions aggregator 320 on the problems that each solution provider option is able to address. The solution provider options can also dynamically pass information associated with availability, scheduling, performance and wait times to solutions aggregator 320. This scheduling information can be collected and processed by service engine 324 and support engine 326. Service engine 324 is configured to process the availability and appropriateness of service solutions 360 while support engine 326 is configured to process the availability and appropriateness of support solution options 370. The availability can include the solution provider's current bandwidth, hours of operation, countries and languages supported, current service levels and types of support offered according to country. Solutions aggregator 320 can combine the availability and appropriateness information provided by service engine 324 and support engine 326 with the identified category, topic, or problem provided by symptoms engine 322 to recommend one or more solution options that can be presented to the customer. In some examples, the customer can also specify additional criteria to refine the solution options presented. For example, the customer can request to have the problem resolved immediately. In response, solutions aggregator 320 can present only service options that are currently available to computing device 310. In one example, solutions aggregator 320, self-help solutions 350, service solutions 360, and support solutions 370 can be a single integrated system configured to provide multiple solutions to the customer. The customers can communicate with solutions aggregator 320 which communicates with self-help solution options 350, service solution options 360, and support solution options 370. In other examples, these solution providers can be stand-alone systems capable of directly communicating with the customer. The customer can submit a request directly to the solution provider and receive assistance with a problem. The customer can also alternatively communicate with solutions aggregator 320. Solutions aggregator 320 can help identify the issue and provide the customer a list of solution options that are relevant to the issue.

### Deep Linking

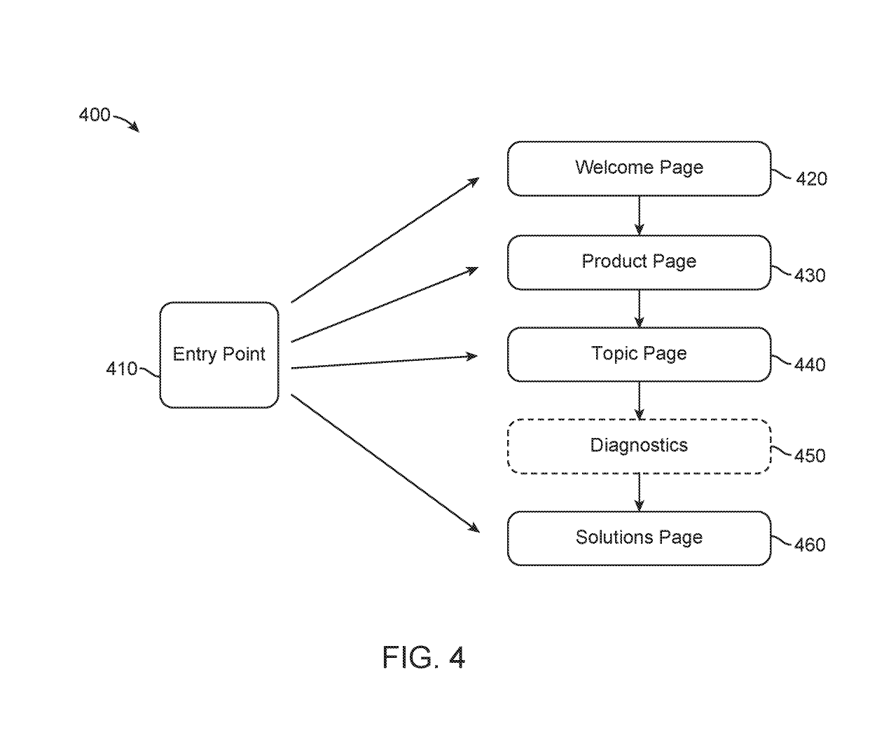

FIG. 4 illustrates an exemplary process of deep linking in the symptoms engine. As described above, the symptoms engine can include a decision tree or other logic to identify a problem with the product or service based on feedback received from the customer. For example, entry flow 400 can follow a general process that begins by transmitting welcome page 420 to the customer device. Welcome page 420 can present a few general options to the customer to determine what action the customer would like to perform. The actions can include starting a new support session, reviewing an existing session, or reviewing billing information, for example. If the customer would like assistance with a product, product page 430 can be transmitted to the customer device to present the customer a list of products that the system can provide solutions for. Once the customer has selected a product, topic page 440 can be transmitted to the customer device to present to the customer topics that can be addressed. Topics page 440 can also ask the customer questions. The symptoms engine can use the customer's answers to these questions to ask further questions, thus incrementally narrowing the customer's assistance request to a specific category, topic, or problem.

In some examples, the symptoms engine can determine based on the customer's issue that diagnostics 440 would be beneficial and should be performed. Diagnostics 440 can transmit a request for diagnostics information from the customer. If the customer approves the request, then diagnostic information can be transmitted to the symptoms engine and be used to further identify the issue. Once the issue has been identified to the extent possible by the symptoms engine, solutions page 460 can be transmitted to the customer. Solutions page 460 can include one or more solutions that the symptoms engine determined would be helpful to the customer. Diagnostics can also be a pre-condition or rule for a particular solution to be offered. The customer can choose from these solutions. The solutions presented can depend on restrictions of the customer and/or the solution provider. For example, the customer can request to only view solutions that can provide immediate assistance. In other words, the customer is not willing to schedule an appointment to troubleshoot the problem at a future point in time. As another example, the symptoms engine can elect to not present solution providers that are unavailable due to geography, language restrictions, or current time of the request. For example, chat support can be not offered to a customer because of the geography, spoken language, or the time of the customer's request. Each of welcome page 420, product page 430, topic page 440, and solutions page 460 can be transmitted to the customer device as a web page to be displayed on a web browser application. Feedback received from the customer via the web browser application can be transmitted to the symptoms engine.

In some examples, a customer can deep link into decision flow 400 through the use of entry point 410. Entry point 410 can be configured to process the customer's request to bypass one or more pages described above. For example, entry point 410 can be used to enter the decision flow at welcome page 420, product page 430, topic page 440, and solutions page 460. Entry point 410 can select an entry point based on the customer's request, information provided by the customer, or the customer's previous interactions with the application or an application where a request for support/service is available. For example, a customer request for assistance can originate from an application running on the customer's device. For instance, the customer can click a get help link when an issue arises in the application. The application can be configured to include metadata associated with the issue such as a crash log or originating source can be transmitted to the symptoms engine along with the request. Entry point 410 can evaluate the metadata to determine the product that is having the issue or the general problem that the customer is having (e.g., problem with headphone jack, problem with CPU, problem with video card, etc.) with the product. Depending on the additional metadata provided in the request, entry point 410 can deep link the user to product page 430 or topic page 440. Alternatively, the customer can be a returning customer trying to review the solutions provided in a previous troubleshooting session. Based on the customer's request, entry point 410 can deep link the customer to solutions page 460.

In some examples, the symptoms engine and the solution aggregator, combined with the customer database, can also pre-populate data associated with the product, topic and issue from deep links and advance the customer directly to the solutions page (with the opportunity to reconfigure and revise). For example, a customer could read a support article on the web site and request assistance. The system could automatically use the support article's metadata to classify the issue (product, topic, issue), present that data back to the customer for validation or revision (instead of requiring them to enter it) and make recommendation solutions for the customer to select. The request for assistance deep links the customer into a level of the decision tree while metadata from the article on the website is used to automatically provide symptom information to the symptoms engine.

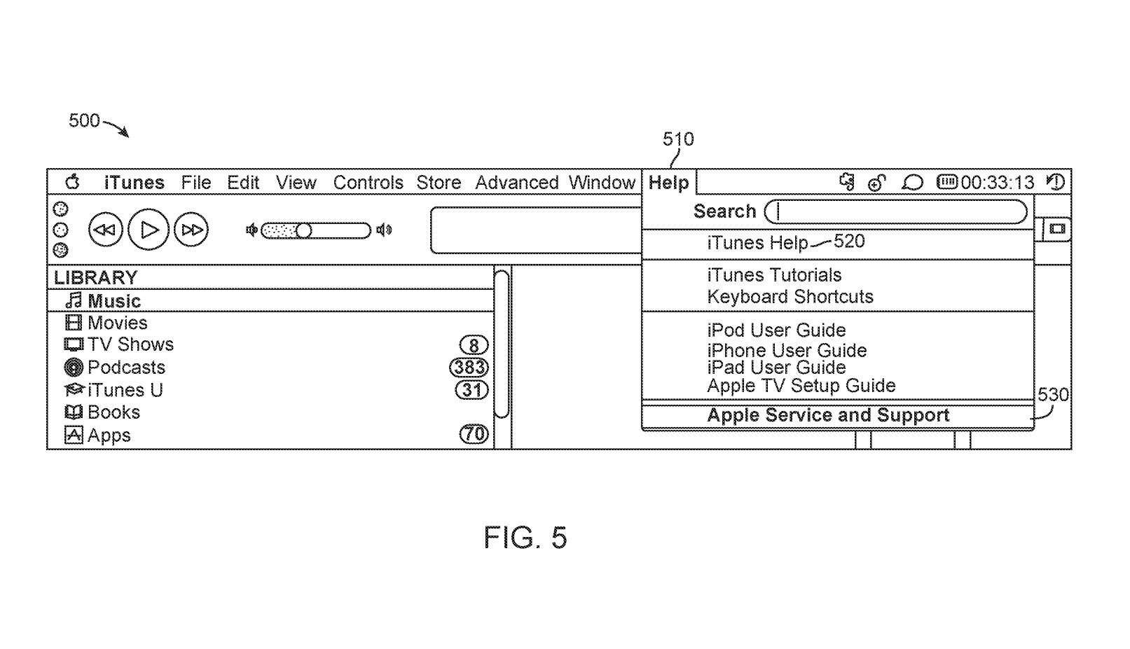

FIG. 5 illustrates an exemplary screen shot of deep linking. As shown, application 500 is a music player application capable of playing back digital media on an electronic device. Here, a user of application 500 has selected help icon 510. Under help icon 510 are help links, including link 520 for “iTunes Help” and link 530 for “Apple Service and Support.” If the user selects link 520, the application can provide self-help documentation. In one example, the application can prompt the user to enter keywords related to the problem in order to identify a document that is related to the customer's problem. In another example, the application can present the user a series of questions configured to locate a document that aims to address the customer's problem. In other examples, selecting link 520 can result in the application passing the help request to a solution provider, such as articles 352 of FIG. 3. The help request can be processed by the solution provider resulting in the solution provider returning one or more recommended solutions that may help the customer with the problem either in the existing application on the web or in the originating application.

Alternatively if the user selects link 530, the application can transmit a help request to a solutions aggregator similar to solutions aggregator 320 of FIG. 3. The solutions aggregator can communicate with the user via the application to identify the issue to a category, topic, or problem and suggest solution options that are available to the user. Here, the user can be deep linked via an entry point when the user request includes metadata information, such as the application the user was using, the unique identifier of the hardware device, or the error code the application generated when help was requested. The entry point can deep link the user to a point in the decision flow that relates to problems with that particular application. If the metadata includes the activity the user was performing when the help request was submitted, the entry point can deep link the user even further into the decision flow to a point that relates to problems with that particular activity. The solutions offered when the user selects link 520 can be the same solutions offered to the user when the user selects the self-help solution from link 530.

### The Multi-Channel Solutions Process

The following figures illustrate exemplary screenshots of the solution process. As a user progresses through the support session, multiple pages can be transmitted to the user's device from the solutions aggregator for presentation to the user. Each page can be presented via a web browser application or other application on the user's device. While these figures illustrate examples of the pages a user may be presented in a support session, they are in no way limiting. Through entry points, it is possible the solutions aggregator can allow a user to skip some of these pages.

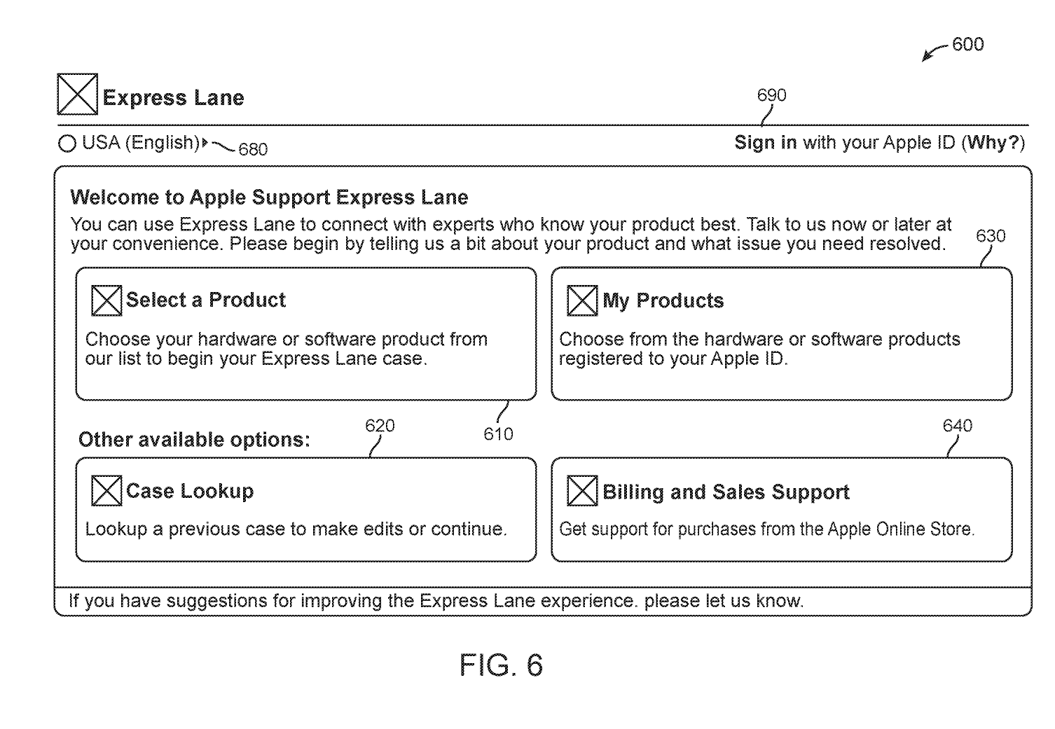

FIG. 6 illustrates an exemplary welcome page that is provided by solutions aggregator to a client device for display to a user. Welcome page 600 can be the default landing page when a user initially communicates with the solutions aggregator. Welcome page 600 includes links 610, 620, 630, 640. Selection of link 610 titled “Select a Product” allows a user to start a support session on a hardware or software product or service. Software products hardware products, and services (e.g., cloud based services or web based services) for which support is available are presented for selection by the user. Selection of link 620 titled “Case Lookup” allows a user to review or continue an existing support session by looking up the support session by the case number. Selection of link 630 titled “My Products” allows a user to peruse hardware or software products (and services) that are associated with the user's account. This can provide the user an easy way to select identify one of their products (or services) that is having the issue. By limiting the presentation of products to only products that are associated with the user's account, the solutions aggregator is able to present to the user a limited list containing products that the user is most likely interested in. Selection of link 640 titled “Billing and Sales Support” can route the user to another system capable of providing support for product billing and sales questions. In other examples, other links can also be presented on welcome page 600.

Welcome page 600 further includes links to set preferences for the support session. For example, the user can use link 680 to set the language and location. The language and location setting can be associated with the user or the product in question. Setting the language and location can result in a change of the solutions available. For instance, repair solutions can be different in one country versus another. As an example, a solution involving the user carrying in the product to a repair store can be an option when the product is in the United States but not in other countries. As another example, a mail in option can be the only option for repair that is supported in certain countries. Furthermore, carrier support and services can vary depending on location, product, and point of purchase, and therefore solutions offered in can depend on the can vary. Similarly, the availability of chat solutions can change based on the user's language preferences. For example, chat support can be supported in English but not in Russian. Depending on the preferences set, the solutions that are available can vary. In some examples, the locale where the user has submitted the request can be used to provide default values for the preferences. The user can always override the default values by selecting link 680.

The user can use link 690 to sign into the support session. When the user has signed in, the solutions aggregator is aware of the user's identity and thus can access databases such as customer case database 330 and customer metadata database of 340 of FIG. 3 to retrieve information associated with the user's account. Access to these databases allows the solutions aggregator to automatically configure itself for the user. For example, the location and the language preferences discussed above can be automatically set. Furthermore, data associated with the user can also be accessed once the user has been identified. For example, solutions aggregator can identify a list of registered products associated with the user account when the user selects link 630. Similarly, the solutions aggregator can identify a list of support sessions associated with the user account when the user selects link 620.

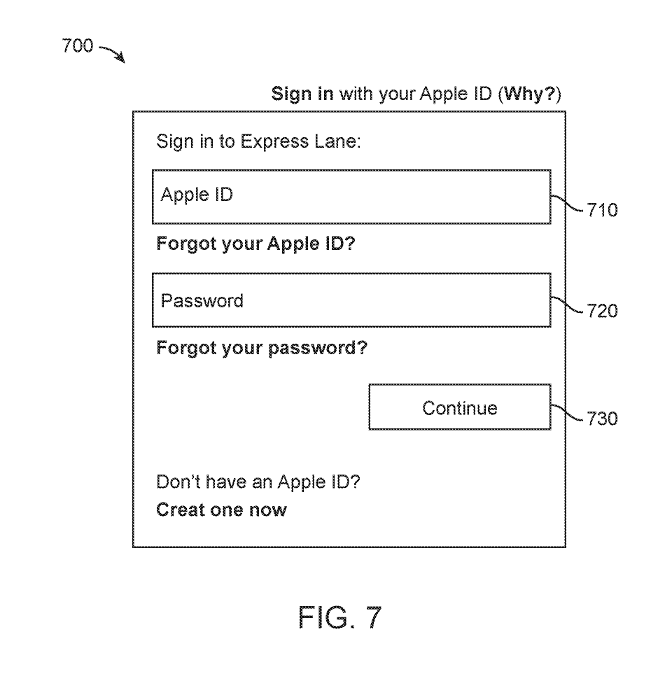

FIG. 7 illustrates an exemplary user sign in prompt. Sign in prompt 700 can be transmitted by the solutions aggregator and presented to the user when the user clicks link 690 titled “Sign in” of FIG. 6. In one example, sign in prompt 700 can pop out and overlay the underlying page when the sign in link is selected. Once the user has successfully signed in, sign in prompt 700 can disappear. Sign in prompt 700 includes two fields. Field 710 is configured to receive the user's account ID. Field 720 is configured to receive the user's password to verify the user's identity. One the user has entered both fields, the user can select continue link 730. If the solutions aggregator determines that the credentials provided are accurate, sign in prompt 700 disappears and the user's identity is cashed in the solutions aggregator. If the credentials provided are inaccurate, the solutions aggregator notifies the user of the error and asks the user to try signing in again.

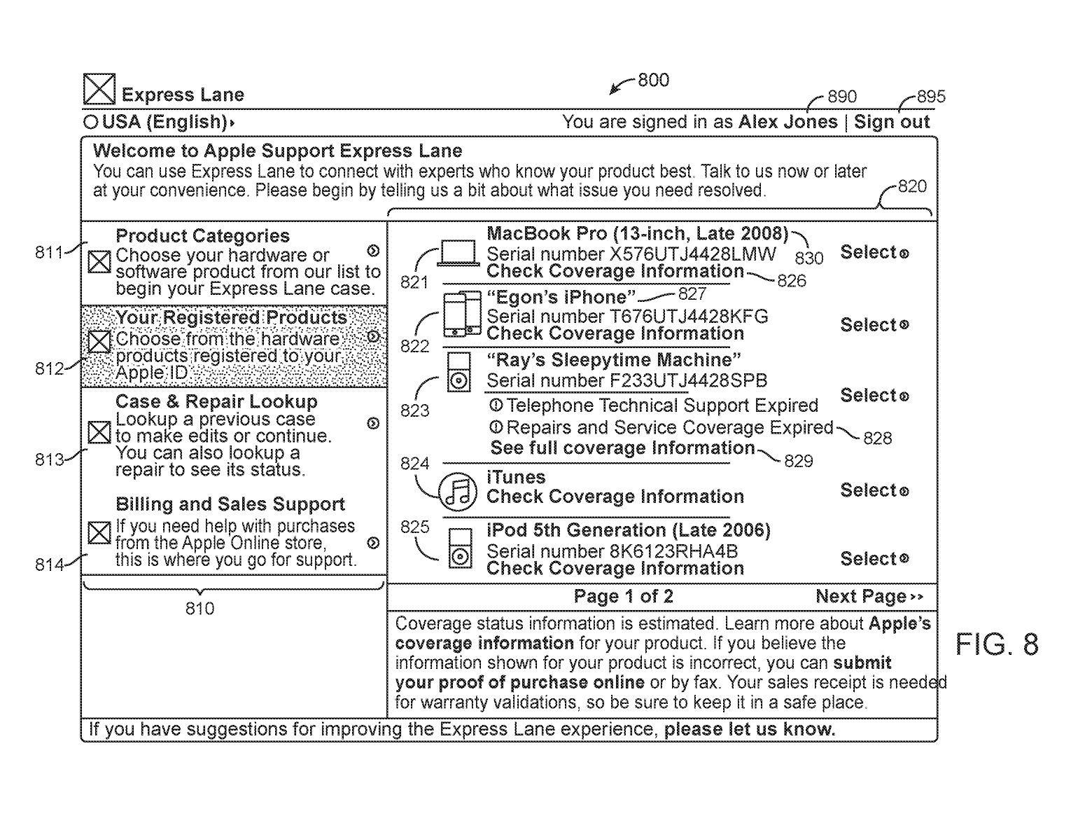

FIG. 8 illustrates an exemplary products page. Products page 800 is configured to identify the user's product that is the focus of the support session in an efficient and user friendly process. Products page 800 can be transmitted to the user's device, from the solutions aggregator, and user feedback from products page 800 can be transmitted to the solutions aggregator for processing and analysis. Products page 800 has been laid out into two main sections: actions section 810 and subsection 820. Actions section 810 is configured to present available action items to the user. In some examples, these action items can be the same action items that were available by selecting the links on the welcome page. Selecting a different action than the current action from actions section 810 can cause the solutions aggregator to change the action performed. When the current action changes, the presentation of subsection 820 can change to information that is relevant to the selected action. Here, the actions available are the same as those shown in welcome page 600 of FIG. 6 and thus include product categories 811, your registered products 812, case and repair lookup 813, and billing and sales support 814. The current action can be highlighted thus making it is easily identifiable.

Subsection 820 is configured to display information that is relevant to the current action. Here, the user has selected your registered products action 812. As a result, subsection 820 presents information related to the registered products that are associated with the user's account. Products (and services) that are registered to the user account that is currently signed in are presented to the user. Here, the name of the user account that is signed in is shown at identifier 890. Link 895 is configured to sign the user out of the account at the end of the support session or if another user would like to sign in. Here, the user account is associated with hardware products 821-823 and 825. The user account is also associated with software product 824. Each product is shown in subsection 820 as an icon and is selectable by the user. A support session can be initiated for a selected product. When the user account is associated with more products than can be displayed in subsection 820, an optional link can be presented to present to the user additional user products on a next page or filter based on product type.

Subsection 820 can also display information related to the user's products. The information can include a nickname for the user's product, if available. If a nickname has not been assigned, the generic product title can be displayed. For example, product 822 has been assigned the nickname “Egon's iPhone” by the user and thus, the nickname is displayed at 827. In contrast, product 821 has not been assigned a nickname by the user and thus, the generic name is displayed at 830. The information can also include links for additional information about the product. For example, each product can be presented with a link to check the coverage information of the product. The coverage information can share the warranty remaining on the product and any other entitlements that are associated with the product. An exemplary link is coverage link 826. Upon selecting coverage link 826, the solutions aggregator can determine any remaining coverage associated with the product and present that information to the user. This can inform the user the types of solutions that are associated with the product before the user proceeds to seek service or support. Here, warnings 828 are presented to the user to notify the user that telephone technical support and repairs and service coverage have expired for product 823. To see the full coverage or additional details about the coverage for a given product, link 829 can be selected after reviewing the remaining coverage, if any. Once a user selects a product, a support session with the product can begin.

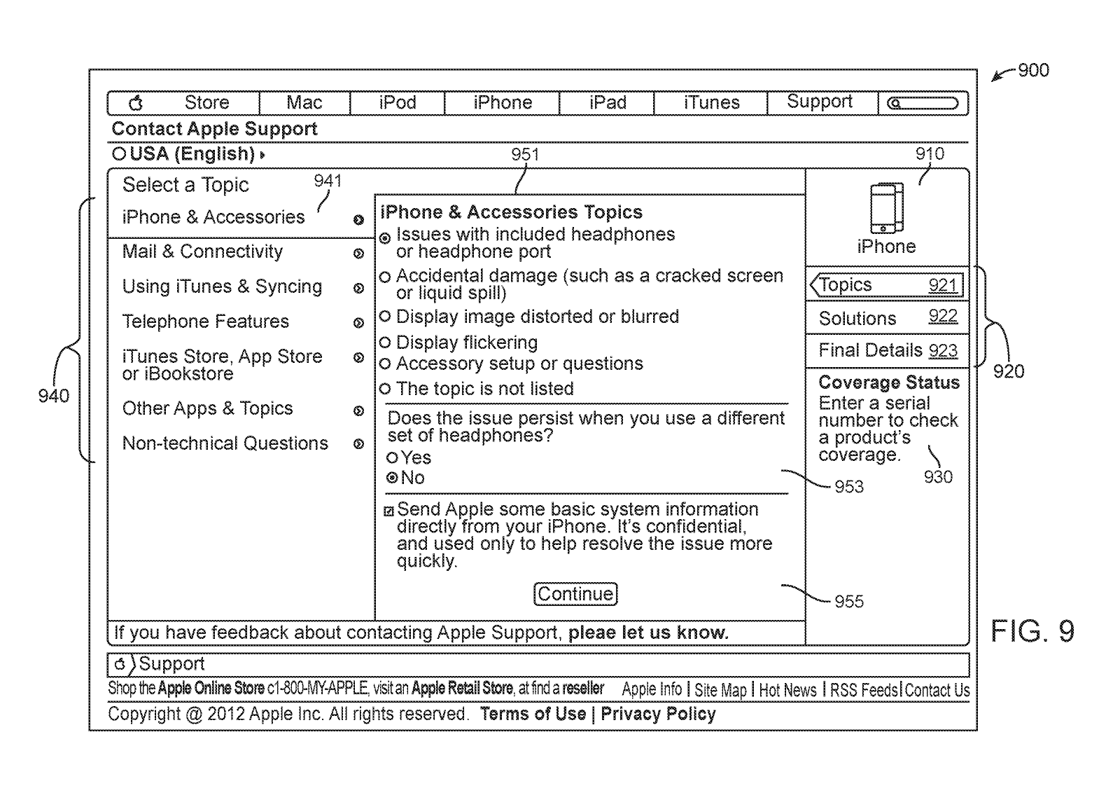

FIG. 9 illustrates an exemplary topics page. Topics page 900 is configured to present support categories and topics to help identify and define an issue or question with the product or service. A support session may be created at this time as the solutions aggregator communicates with the user to diagnose the issue. The solutions aggregator can vary the topics presented to the user according to the product or service selected. For example, certain topics such as mail & connectivity may be applicable to a laptop but not to a media player. The product selected is shown at icon 910. Here, the product is a smart phone. Next to icon 910 is progress indicator 920 configured to display the progress of the user through the support session. Progress through the support session can be divided into four portions: product 910, topics 921, solutions 922, and final details 923. The topics portion can include topic pages to help identify the issue. The topics pages can present various symptoms to the user to help identify the problem. The solutions portion can include pages to recommend solution options to the user according to the identified problem. The final details portion can include pages with details associated with a particular solution when the user has selected a desired solution. For example, a solution involving carrying in the product can require scheduling an appointment with a store. Pages associated with scheduling an appointment can be presented to the seller to finalize the details of the solution. The present section can be indicated through highlighting. In some examples, solutions aggregator can also present the coverage status for the device when the user selects the coverage link 930. The coverage status can describe the entitlements of the product. Reviewing the coverage status for the device can allow the user to review what solutions the product is entitled to.

Potential symptoms and problems with a product can be categorized into topics. These topics can be presented in topic list 940. Selection of a topic can cause solutions aggregator to present subtopics, follow up questions and in-line messages. This process can continue until the symptoms engine of the solutions aggregator exhausts its efforts and defines a problem or question. The problem identified can be a specific problem or a more general problem. This can depend on the results of the decision tree, which can depend on feedback received from the user, other summary information received from the product or solution providers, and also diagnostic information received from the product. In some examples, the topics and subtopics can be organized in a decision tree structure where depending on the topic, subtopics, and symptoms selected by the user, different categories or questions are presented to the user. Here, the user has selected topic 941 titled “iPhone and Accessories” (as indicated by the highlighted selection). Selection of this topic results in the presentation of subtopics 951 titled “iPhone & Accessories Topics.” The subtopics presented are based on the topic selected. Similarly, selection of an option from subtopics 951 results in the presentation of symptom 953 which asks the user “Does the issue persist when you use a different set of headphones?” Depending on the user's answer to the symptom, other symptoms can be presented to incrementally identify the issue. This can continue until the solutions aggregator has exhausted its ability to define the issue or a solution has been identified.

In some examples, the solutions aggregator can request permission from the user to retrieve diagnostic information from the product. Requests for diagnostic information can depend on the current state of the support session. For example, the solutions aggregator can transmit a request to retrieve diagnostic information when the user responses to topic page 900 results in the traversing of particular nodes in the decision tree. In another example, the decision of whether to transmit a request for diagnostic information can depend on the product being diagnosed or the channel that would like to obtain this data. Solutions aggregator can determine if the product stores diagnostic information and if the product is able to communicate with the solutions aggregator. To determine which products can communicate with the solutions aggregator, a table or other data structure can be maintained. The process to retrieve diagnostic information can include the solutions aggregator communicating with a utility application installed on the product to request the diagnostic information. Once received, the diagnostic information can be treated as symptoms information and be processed and stored in the customer case database.

The diagnostic information received includes product metadata that can be used by the solutions aggregator to diagnose the issue. While using the diagnostic information to diagnose the issues, the solutions aggregator can determine that other problems with the product that the user is not aware of have been revealed via the diagnostic information. For example, diagnostic information received to troubleshoot an issue with the headphone port can reveal that the product also has a problem with the battery. When secondary problems are discovered, the user can be notified. If the secondary problems revealed are of a higher priority than the current issue being diagnosed, the current support session can be saved and a new support session can be created to address the secondary problem. In some examples, the solutions aggregator can deep link the user to the solutions page in this scenario if the problem has already been identified. In other examples, only diagnostic information related to the issue being diagnosed is retrieved from the product to minimize the information retrieved from the product. However, retrieving a subset of the available diagnostic information can prevent issues unbeknownst to the user from being discovered. The diagnostic information received can also include unique identifiers to identify the product and hardware/software associated with the product. By receiving the unique identifiers directly from the product, potential errors from the user manually entering the product information can be eliminated. The product information may have to be entered to check the solutions that the product is entitled to, recalls that are associated with the product, and others.

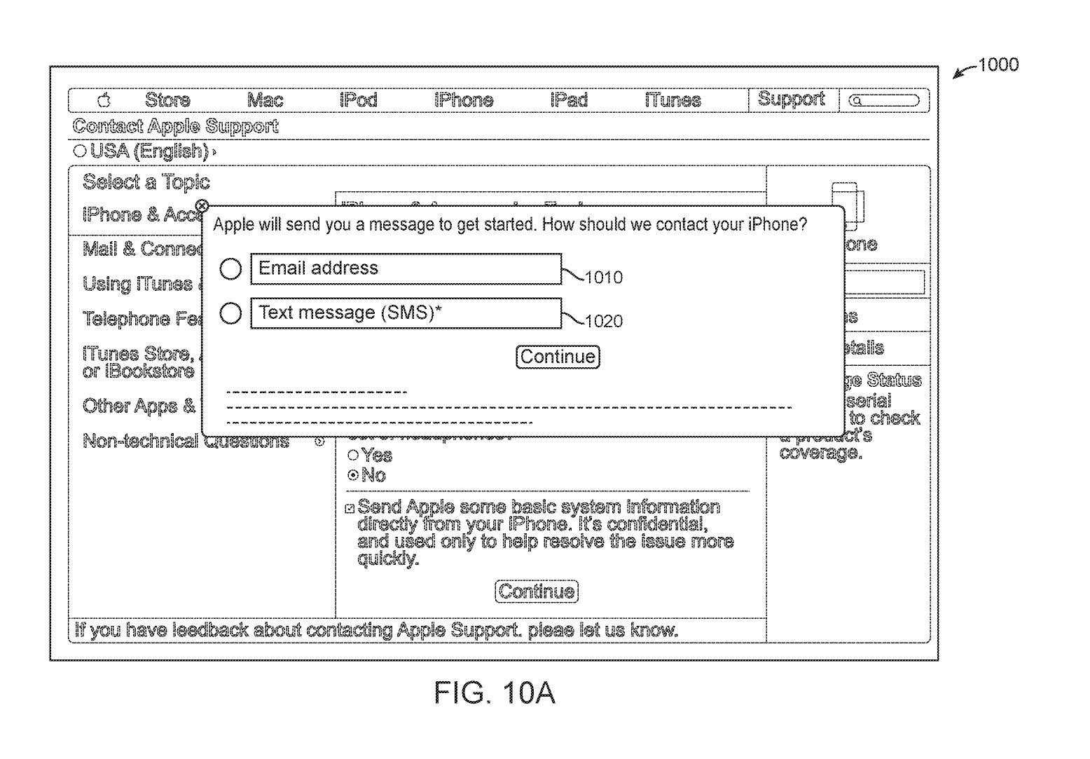

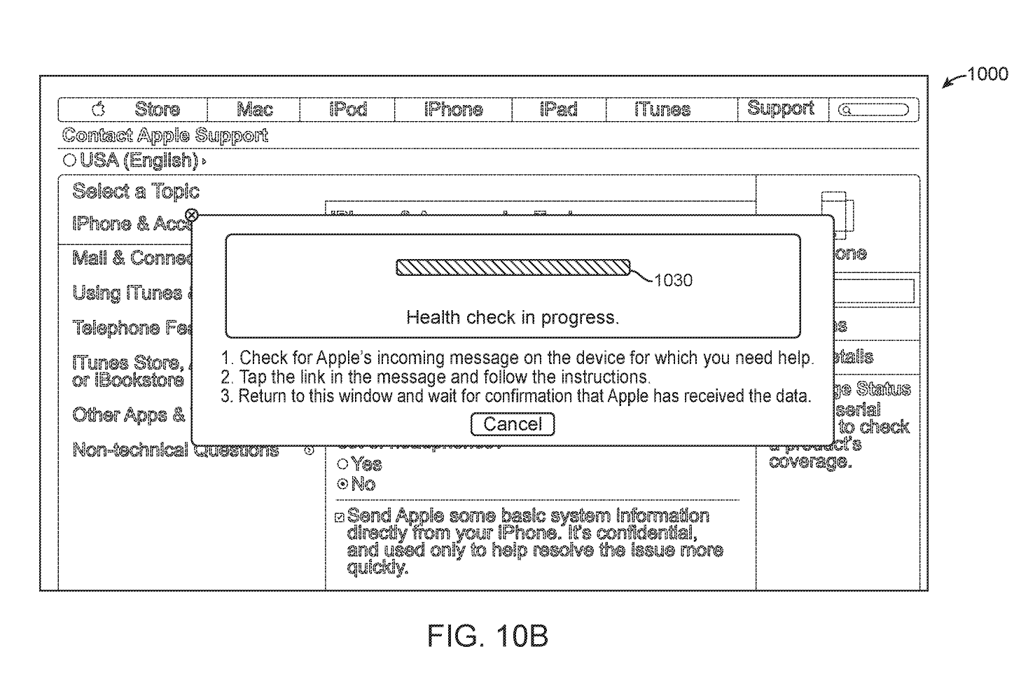

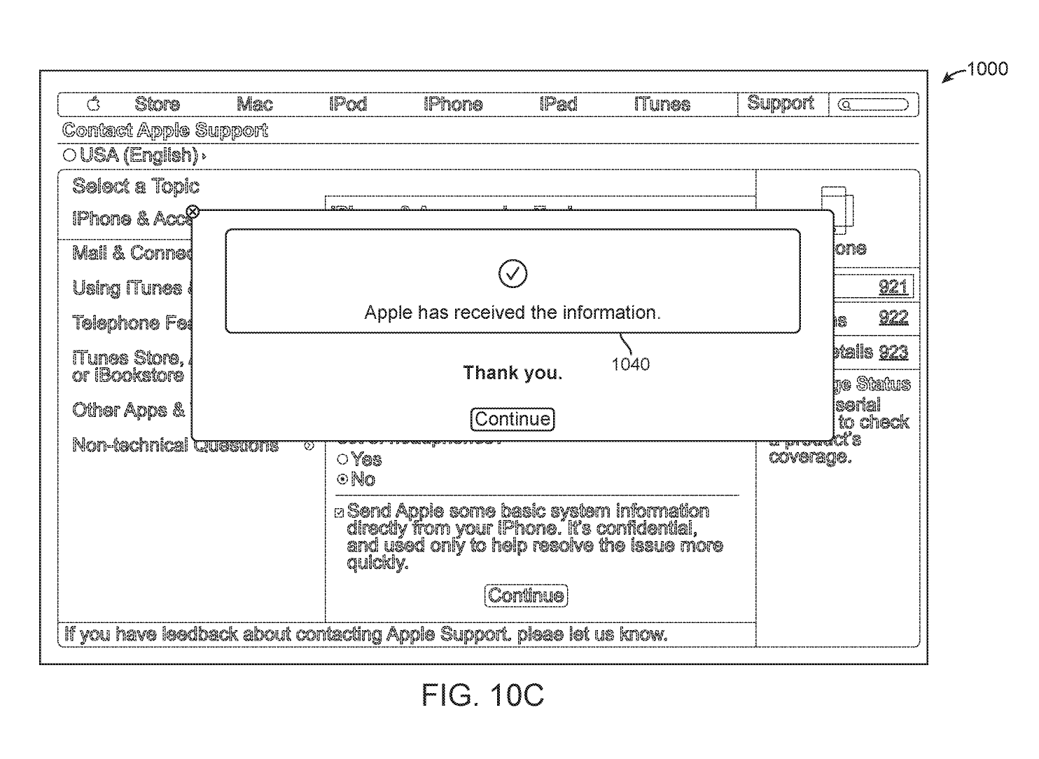

FIGS. 10A-C illustrate an exemplary pop up user interface configured to request diagnostic information. FIG. 10A illustrates user interface 1000 after the user has agreed to send diagnostic information. User interface 1000 can transmit a request to the user device for contact information for the product or the device running the product if the product is software. The contact information is used by the solutions aggregator to contact the product or the device running the product to request the diagnostic information. As shown, user interface 1000 includes two fields. Depending on the product or the user's preference, an email address can be entered into field 1010 or a phone number can be entered into field 1020. Alternatively, user account name and password could also be used. In yet other examples, user interface 1000 can be skipped because the contact information can be stored in the user account information, which is retrievable from a customer metadata database. After receiving the contact information, the solutions aggregator transmits a link to the product using the contact information. The solutions aggregator then waits for the product or the device running the product to click on the link and begin transmitting the diagnostic information to the solutions aggregator. The solutions aggregator also can generate follow up user messages via other systems that match the data, if the diagnostic data submitted does not match the product it was set up to collect (e.g., the serial number presented in the diagnostic data does not match the device serial number submitted as part of the support request). In some examples where the user device requesting the support session is also the product being diagnosed (or the product being diagnosed is installed on the user device requesting the troubleshooting session), the diagnostic information can be transmitted to the solutions aggregator directly without requiring the user to enter contact information into the interface.

FIG. 10B illustrates user interface 1000 when the diagnostic information is being received by the solutions aggregator. User interface 1000 displays progress bar 1030 to keep the user notified on the status as the solutions aggregator receives the diagnostic information. In some examples, receiving the diagnostic information can occur incrementally. For example, diagnostic information can be requested based on the issue the solutions aggregator is attempting to diagnose. Depending on the diagnostic information received, additional diagnostic information can be requested from the product. By receiving the diagnostic information in this piece meal fashion, only diagnostic information that is relevant to the issue is received from the product. In other examples, a portion of diagnostic information can be retrieved from the product when the diagnostic information request is received.

FIG. 10C illustrates user interface 1000 when the solutions aggregator has finished receiving the diagnostic information. Once the diagnostic information is received, a notification can be transmitted to the user. Here, notification 1040 containing a check mark and the text “Apple has received the information” can be presented to the user. After the user has read the message, the user can elect to continue with the support session. At this point in time, user interface 1000 can disappear and the user can return to the support session.

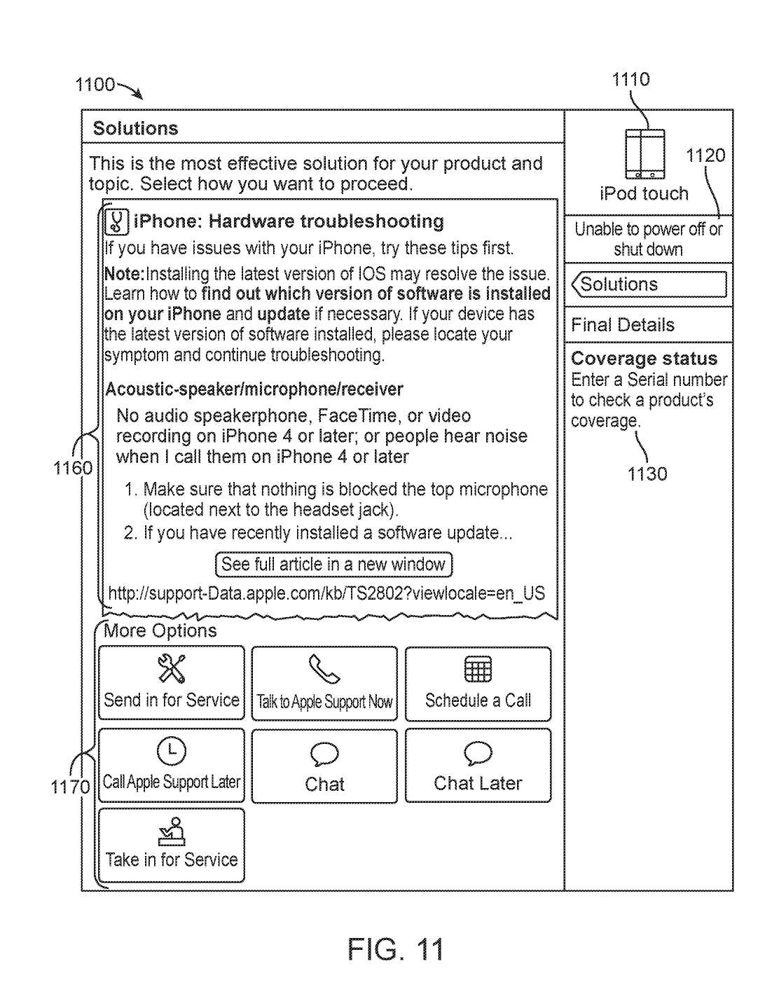

FIG. 11 illustrates an exemplary solutions page. Solutions page 1100 is configured to present the user with solution options based on the identification of the user's question or issue. The solutions presented can be based on how the solutions aggregator rates each solution to provide a recommended solution accompanied by all relevant solutions to afford the customer maximum choice. The solutions can be recommended and presented in their entirety based on a variety of factors including the relatedness of the solution the issue/problem (e.g., does an article exist that has a high probability of being relevant to the issue or problem identified?), the entitlements of the product, the locale of the user or product, the current time at the user or product, the bandwidth of each solution, availability of the solution for that product/service, knowledge of the providers performance and customer satisfaction with the solution, solutions providers expertise on the best format to support the issue (e.g., chat is a challenging medium to identify wireless or network connectivity questions), the point of purchase of the device, the user device platform, and others. Business rules can be formed based on these factors. The business rules can be expressed in an object oriented style. In other words, the factors can form classes and the classes can be used to define the business rule for a particular scenario. Moreover, a business rule can be depend on one another through inheritance. Depending on the scenario, the most relevant business rule can be applied. The different scenarios can take into account the product, the locale of the product, and the specific symptom. Once a business rule is applied and the solutions are rated, each solution can be ranked. A predetermined number of solutions from the ranked list can be returned and recommended by solutions aggregator. Here, solutions page 1100 includes icon 1110 that represents the product or service having the issue. Solutions page 1100 also includes the identified problem or question at 1120 and link 1130 to check coverage status for the product. In some examples, entering the serial number or other unique identifier associated with the product can narrow the solutions options presented to solutions options that the product is entitled to without purchasing additional entitlements. For example, the user can enter the serial number of the product using link 1130. The solutions aggregator receives the serial number and looks up the warranty coverage (i.e., entitlements) that are tied to the product. Upon determining that warranty hardware coverage is still available but the complimentary tech support coverage has ended, solutions aggregator can present repair options based on that coverage but advise customers that if their support request is not hardware or exception related they will be required to pay for technical support. In other examples, the serial number can be received through the diagnostic information and automatically applied.

Other factors that can be considered by the solutions aggregator in recommending the solutions can include the product (some solutions may be favorable for certain products), the problem (some problems may be require certain solutions or may not be solved by certain solutions or may prefer certain solutions), solution availability, the locale and/or time at the user device's location, or the locale and/or time at the products location. For example, certain problems with mobile phones may be best handled by the mobile carrier or not offered via the phone as one might not be available due to the issue. Similarly, certain problems with the hardware of the product are best handled by repair services. Certain solutions that require human resources can be limited to the hours of operation of the solution channel. Thus, the current time and day at the user device can affect the solutions recommended.

As yet another example, some solutions can be available only in certain locales. Of the solutions available, the one solution that is ranked the highest can be recommended over the others. Here, the article solution is recommended and thus is presented prominently in space 1160 while the other solutions can be presented as additional options in space 1170. The support solutions available can include self-help articles (e.g., documents), speaking with the community (e.g., forums), online repair creation (e.g., filling out forms online and mailing in the product), carry-in referral (e.g., carrying in the product to a brick and mortar store), mobile carrier referral (i.e., recommending third parties who are better suited to handle the problem), authorized service provider referral (i.e., recommending third parties who are available to handle the repair), click-to-call (e.g., click a button to make a phone call), scheduled callback (e.g., schedule a time for the solution channel to call the user back), call later (e.g., schedule a time for the user to call back and save the record for future use and faster connection), click-to-chat (e.g., live chat), chat later (scheduled chat a later point in time and save the record for future use and faster connection), a specialized phone support option where screen sharing is appropriate and applicable, and email. In some examples, the solutions aggregator can combine solution selection rules, along with real-time data from the support channels to recommend a solution for the user. In some examples, the user can provide feedback after the support session and comment on the value of the solution. This can provide a feedback loop so that the solutions aggregator can determine the effectiveness and applicability of a solution to a given problem or issue. This can be taken into account in future support sessions with the goal of providing solutions that are highly effective in resolving the customer's issue.

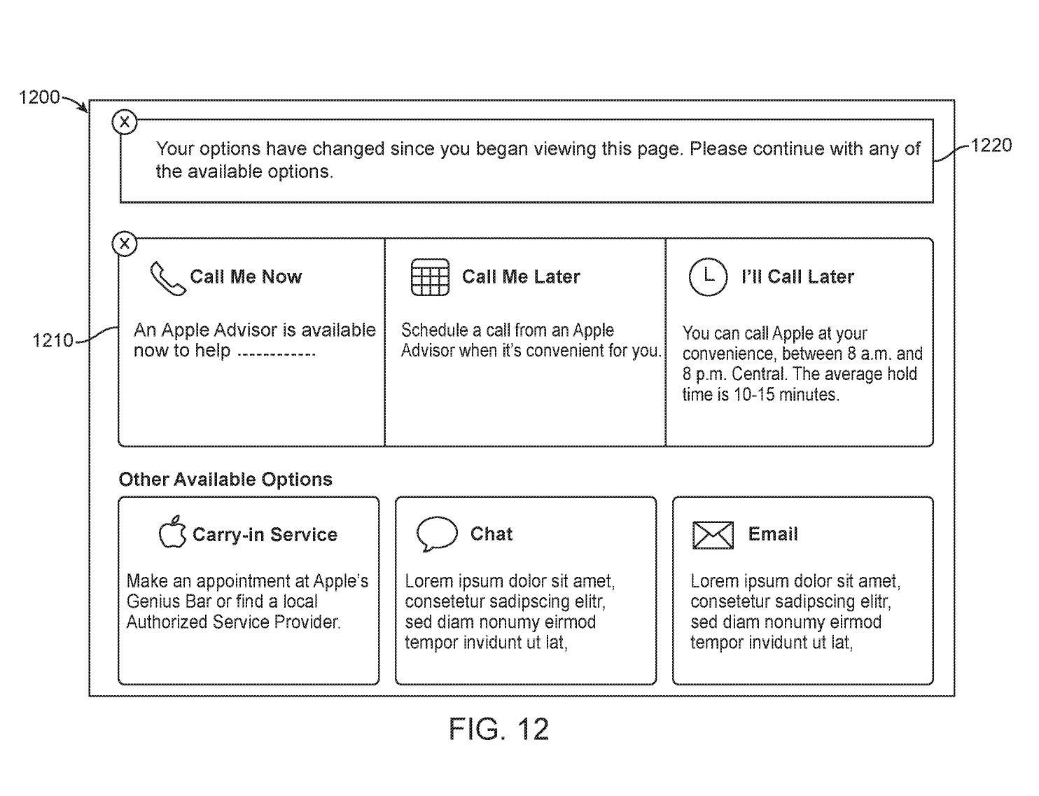

FIG. 12 illustrates an exemplary user interface to inform the user of a change in the solution options presented. This can occur when the availability of a solution were to change in real-time. For example, solutions aggregator may simultaneously be supporting multiple users seeking support and service solutions. Although a solution option may be available when the solutions were presented to a given user, the solution option can be unavailable when the user selects that option because other users have also selected that solution, thus using up the available bandwidth in the solution channel associated with the solution. Here, user interface 1200 presents a multiple solution options that are available to the user. The recommended solutions are telephone support solutions (e.g., call me now, call me later, or I'll call later). Where the user communicates with a technical advisor through a phone call. After the solution options are presented to the user, a period of time may elapse before the user selects an option. Since the solutions provided are based on various factors including the availability of the support channel offering the solution, the solution options may dynamically change before the user makes a selection. Changes to the availability of a support channel can be updated at the solutions aggregator, which in turn propagates that information down to the user in real time. This can include the addition or removal of a solution option. Here, solution option 1210 titled “Call me now” has become unavailable due to changes in the availability at the solution channel (e.g., during the period of time that the solution option has been offered to the user, other users chosen to use this solution option).

In one embodiment, the solutions aggregator can passively notify the user of changes to the solution options. If the solution options presented on the solutions page changes, a pop up notification is presented to the user to inform him of this change. Notification 1220 is an example of a pop up notification. After the pop up notification is closed by the user, changes to the solution options can be highlighted through blinking or highlighting to update the user on the recent change. For example, a solution option may no longer be available because it is after business hours (for service or support solutions) or the system is down (for self-help solutions). As another example, if an option that was originally not displayed is now valid because the option just became available or the system is back up, the new option appears on the solutions page and a notification is presented to the user. The new option can be highlighted by pulsing twice in a 5-second span, followed by the option being displayed as any other available solution option.

In another embodiment, the solutions aggregator can actively notify the user of changes to the solution options. Active notifications notify the user of changes to the availability of solutions as the user actively requests a solution from solutions aggregator. This can result in processing overhead from sending the user updates whenever the availability of solutions changes. For example, a solutions page is presented to the user. When the user selects a solution, solutions aggregator can contact the selected solution and confirm that availability still exists. If the solutions aggregator determines that the option is no longer valid (for example, because it's now after hours or the system is down), the solutions aggregator can transmit a message to the user such as “We're sorry, but this option is no longer available. Please choose another option.” In some examples, the previously selected solution that is no longer available can become inactive from the solutions page.

After the solutions aggregator determines that the solution option selected by the user is available, the solutions aggregator can also determine if support entitlement is required and if so, verify that the product is entitled to utilize the solution. Verification can be performed by checking entitlement rights associated with the product. If a solution option has been selected for which the product does not have entitlement rights for, or if the product is not registered, solutions aggregator can notify the user of this fact and also offer the user the option to purchase the entitlement rights for the solution and/or register the product. In one example, the solutions aggregator can be configured to process purchases of entitlement rights. In other examples, the solutions aggregator hands off the purchase request to a third party configured to handle the sales of entitlement rights. Once the rights have been purchased, the solutions aggregator can route the user to the desired solution. In other examples, the user can set personalized options such that solutions aggregator avoids presenting solutions which the product is not entitled to.

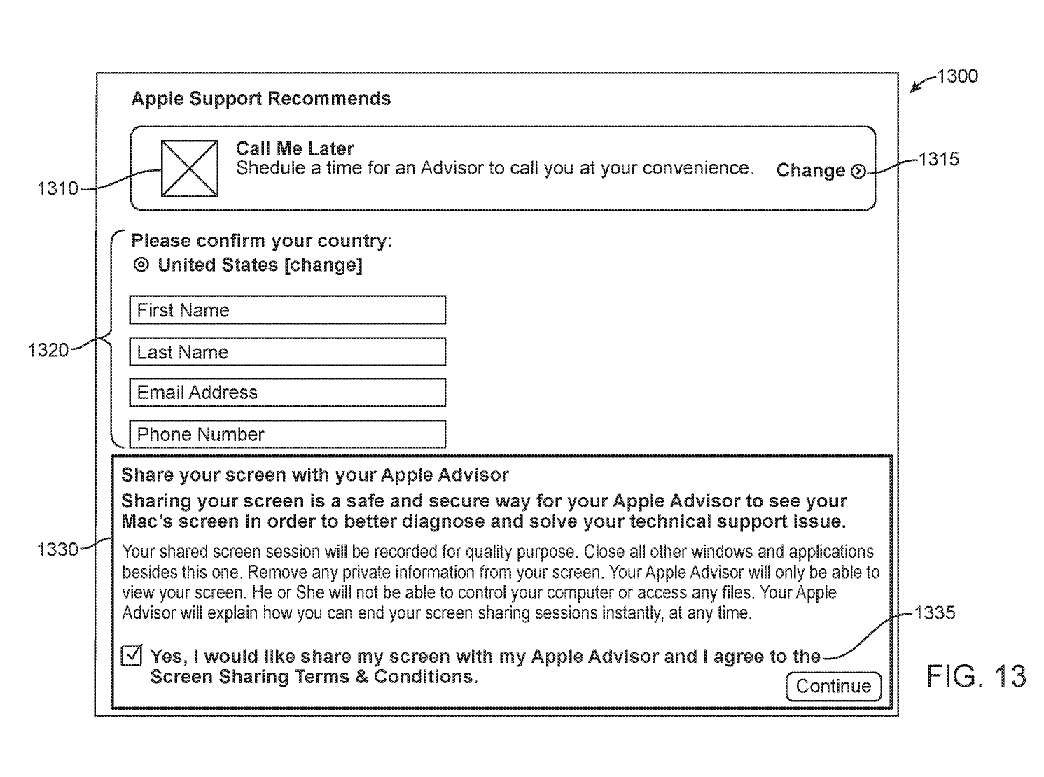

FIG. 13 illustrates an exemplary support solution page. Solution page 1300 can be a page configured to present a solution where the user communicates (whether it is on the phone, in a store, via online chat, or via email) with a live person to resolve the problem. Solutions page 1300 can be partitioned into multiple sections including title section 1310 and contact section 1320. Title section 1310 can display an icon and text to identify the solution currently being recommended. This can be an easy way for the user to identify what the solution is. The solution presented can be changed by selecting link 1315. Solutions page 1300 also includes contact section 1320. Contact section 1320 can be presented by the solutions aggregator when the solution involves future contact with the user or the product. This can include support options such as call later, schedule call back, or scheduled repair. Solutions that involve future contact with the user can be recommended by the solutions aggregator based on the bandwidth available at the solution channel or the preferences of the user. For example, user preferences can specify that scheduled callbacks are preferred by default or when the user is using a particular device.

In some examples, solution page 1300 can further include option 1330 for screen sharing. Screen sharing allows a technical advisor to gain control or visibility of the product. By granting the technical advisor access and control over the product, the technical advisor can more quickly and efficiently troubleshoot the user's problem. For example, the technical advisor can try different solutions on the product without having the user act as a median to execute the technical advisor's instructions. In one example, control over the product can be limited to a period of time that is defined by the support session. The technical advisor can access the product but only while the user is communicating (via a call or chat) with the technical advisor to troubleshoot the problem. When the troubleshooting session is over, the technical advisor's access and control over the product can be terminated. Here, the user can click checkbox 1335 if he or she would like to participate in a screen sharing session.

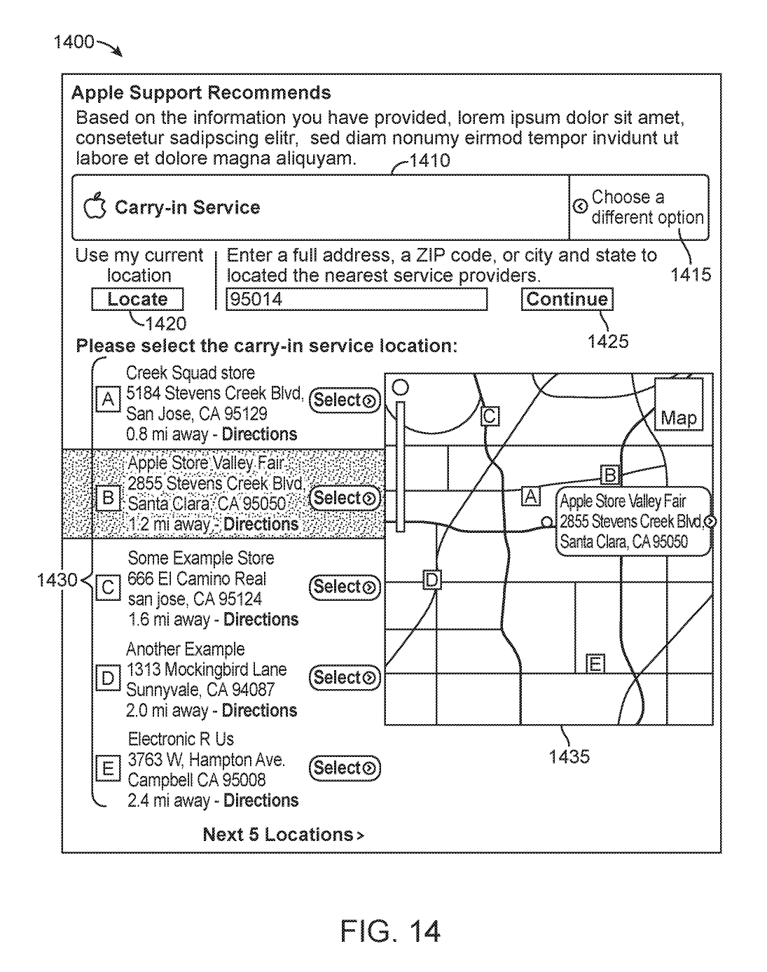

FIG. 14 illustrates an exemplary service solution page. Solution page 1400 can be a page configured to present a solution where the user submits the product for carry-in repair. Solutions page 1400 can be partitioned into multiple sections including title section 1410, current location link 1420, address field 1425, and results section 1430. Title section 1410 can display an icon and text to identify the solution currently being recommended. This can be an easy way for the user to identify what the solution is. The solution presented can be changed by selecting link 1415. Solutions page 1400 also includes current location link 1420 and address section 1425. Current location link 1420 and address field 1425 present the user two options for entering a geographical location to search for nearby service providers (e.g., repair centers). If the user selects current location link 1420, the current location of the user's device (or alternatively the product) can be determined through the user of a global positioning system and service locations nearby the current location can be queried. If the user selects address field 1425, the service locations nearby the address entered by the user can be queried. The solutions to the query can be presented in results section 1430. Optionally, map 1435 can also be presented in the results section to identify the geographical location of the service locations returned from the query.

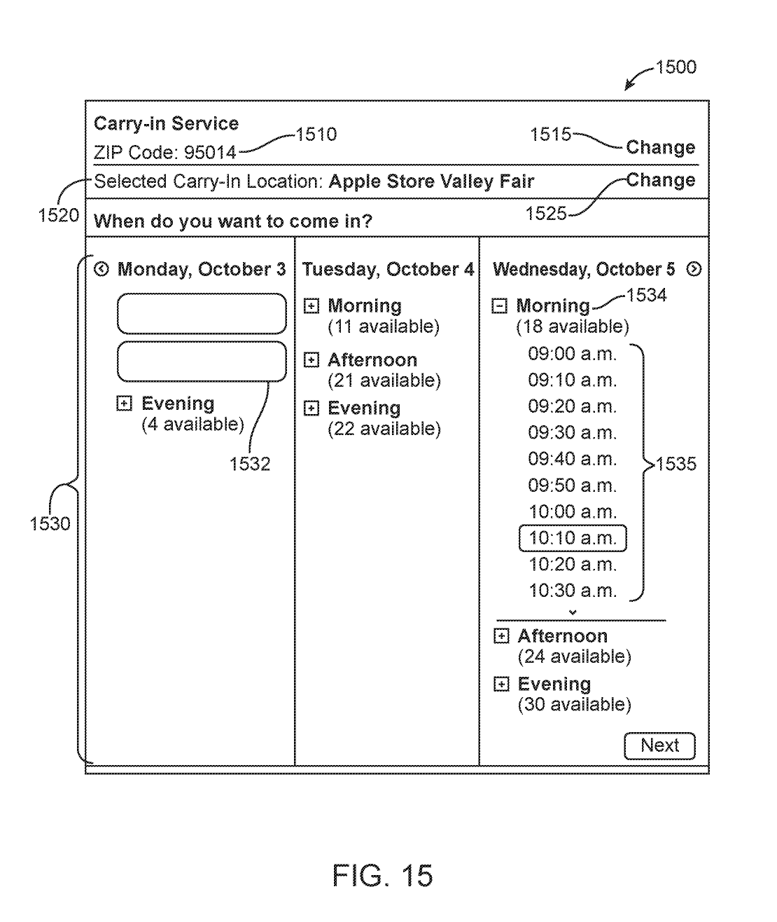

FIG. 15 illustrates another exemplary service solution page. Solution page 1500 can be a page that is presented following the selection of a retail store provider from solution page 1400 of FIG. 14. Solution page 1500 can be configured to finalize a time to perform the service solution. By scheduling a time to bring in the product, the retail store solution provider can minimize the amount of time the user spends at the provider to drop off the product. This same situation could be applied to third-party solutions providers with their systems (in the future). Here, solutions page 1500 can be partitioned into multiple sections including location section 1510, store section 1520, and schedule section 1530. Location section 1510 can present the geographic location that the user had searched to find the current store presented in store section 1520. Selecting link 1515 can allow the user to go back to solution page 1400 to change the geographic location. Selecting link 1525 can allow the user to go back to solution page 1400 to change the selected store while maintaining the geographical location sued in the search. Scheduling section 1530 presents time slots that are currently available for scheduling. The time slots can be organized into time periods, such as morning, afternoon, and evening. If a time period does not contain any available time slots, the time period can be removed as shown in 1532. Selecting a time period with available time slots expands the time period and presents the time slot. Here, selecting time period 1534 results in the presentation of time slots 1535. As the time slots are filled by users, solution page 1500 may be dynamically updated to reflect the change in availability. If limited time slots are available for a given location are available, the solutions provider could also expand the geographic radius of the availability search to pull in additional appointment options from nearby retail store providers (e.g., if the Soho store has limited appointments on a given day, it could display more immediate options, if available to go to the Union Square store instead).

In some examples, the solutions aggregator may collect and hold some user information to confirm that the user is bringing in the product that was diagnosed with the problem rather than another product. The user information can be utilized to assist with investigations of misuse. Exemplary user information can include the IP address for the user's session or the DeviceID of the user's computers.

### Exemplary Methods

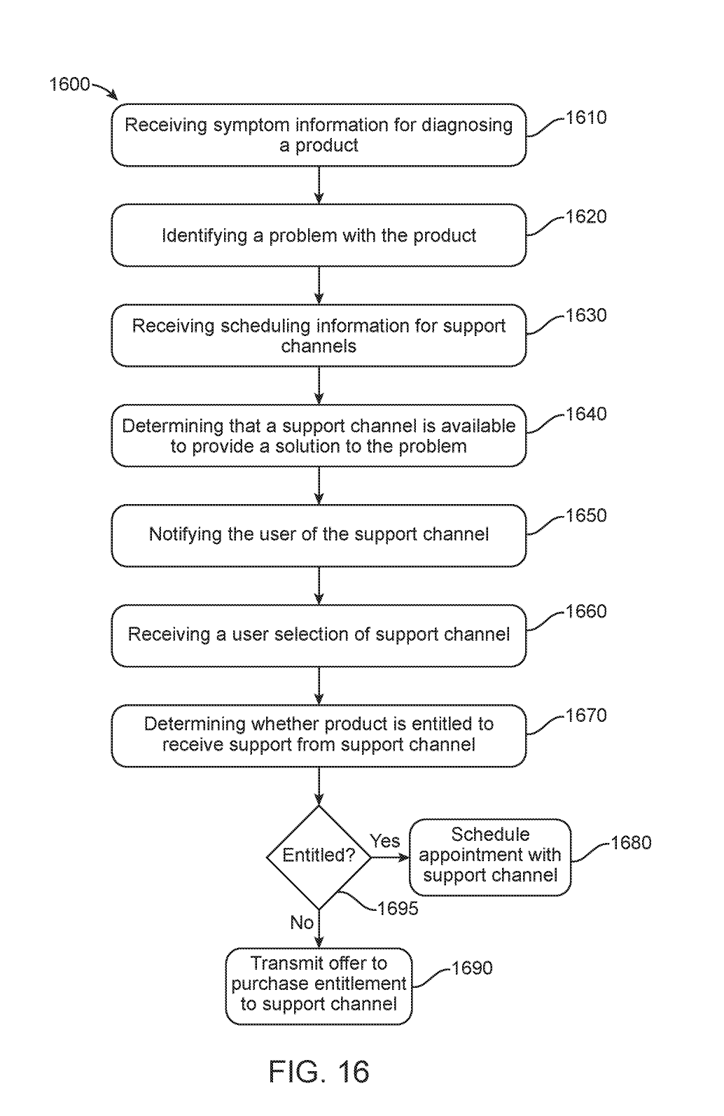

FIG. 16 illustrates an exemplary process for providing support and service solutions for a product. The process can be stored as computer readable code and processed by a processor, such as a server on an online store. Process 1600 receives symptom information for identifying a product and issue (1610). The symptom information can include feedback provided by a user device in response to a symptoms page that was transmitted to the user device. The symptoms page can include multiple user identifiable symptoms which, when selected by the user, provides feedback that is used to identify a problem with a product. The symptom information can also include metadata associated with the issue that was received along with a request to troubleshoot the issue. After receiving the symptom information, a problem can be identified with the product (1620). The problem can be identified by processing the symptom information through a decision tree or other data structure or algorithm to try to identify the problem. Once the problem is identified (or identified to the best of the decision tree's ability), scheduling information for multiple support channels can be received (1630). The scheduling information can include data describing the availability of the support channel along with the problems that a support channel is capable of supporting. This support information can be combined with the identified problem to rank the support channels into a recommended solution where the preferred support option are more likely to be able to be resolved while the other solutions can be chosen as an alternative based on customer preference. The ranked list of support channels can be filtered to remove solutions which the product being troubleshot is not entitled to. Of the recommended list, a support channel is determined to be available to provide a solution to the problem (1640). That support channel can be presented to the user (1650). The user can elect to use the support channel or select another support channel that is available. If the user selects to use the support channel 1660), a determination is made as to whether the product is entitled to support from the support channel (1670). A product's entitlement to a support channel can depend on the warranty coverage of the product, type of issue or question, or other considerations. A determination is then made as to whether the product is entitled (1695). If the product is entitled, an appointment is scheduled with the support channel (1680). If the product is not entitled, an offer is transmitted to the user device or the product to purchase entitlement support to the channel (1690).

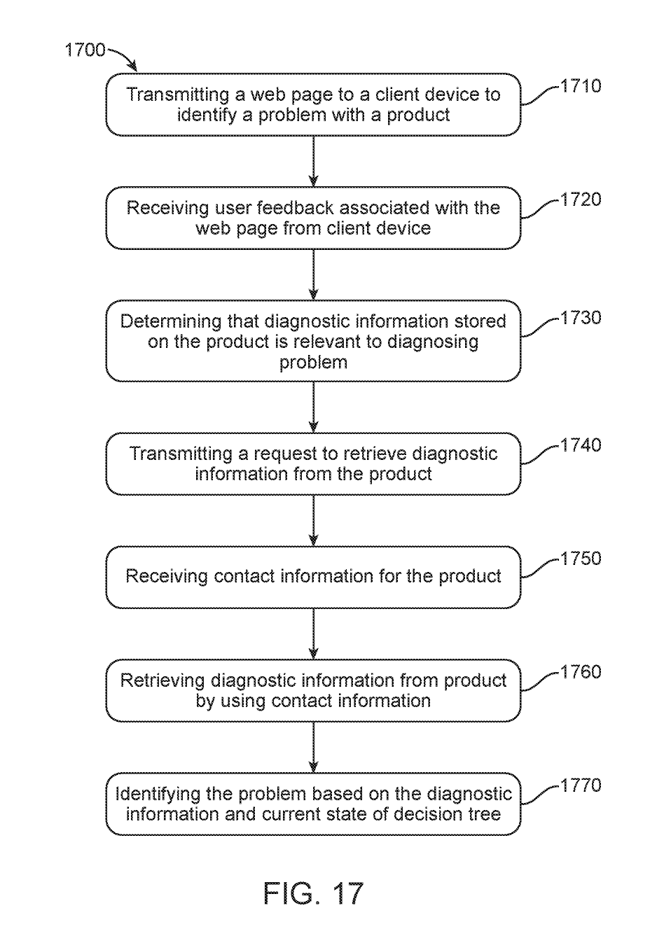

FIG. 17 illustrates another exemplary process for providing support and service solutions. The process can be stored as computer readable code and processed by a processor, such as a server on an online store. Process 1700 transmits a web page to a client device configured to identify a problem with a product (1710). The web page can be a symptoms page containing multiple symptoms for the user to choose from. Once the user selects the symptoms that are applicable to his problem, the user feedback is received from the client device (1720). Based on the user feedback, a determination can be made that diagnostic information stored on the product is relevant to diagnosing the problem (1730). The determination can lead to transmitting a request to the product to retrieve diagnostic information (1740). In response to the request, contact information for the product can be received from product (1750). The contact information can include an email address, a phone number, an IP address, or other identifier that is specific to the user. Once the contact information is received and the customer assents to the request, the contact information can be used to retrieve diagnostic information from the product (1760). Once the diagnostic information is received, the problem can be identified based on the diagnostic information and the current state of the decision tree. (1770)

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, solid state drives, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be applied other types of files to control the secure deletion of those files and other copies of those files from storage. Those skilled in the art will readily recognize various modifications and changes that may be made to the principles described herein without following the example embodiments and applications illustrated and described herein, and without departing from the spirit and scope of the disclosure.

We claim:

1. A method, comprising:
receiving, from a user terminal, a request to initiate an interactive support session with the user terminal regarding a performance issue with a computing device, the interactive support session configured for providing interactive user interface elements at the user terminal for traversing a decision tree to identify at least one channel from a plurality of support channels;
obtaining, from at least one connected system, previously collected information regarding the computing device;
selecting an entry point in the decision tree based at least in part on the previously collected information; and
initiating the interactive support session with the user terminal based on the entry point.

2. The method of claim 1, further comprising receiving, from the user terminal, metadata corresponding to with the performance issue for the computing device, and wherein the selecting is further based on the metadata.

3. The method of claim 1, wherein the request further comprises symptom information describing the performance issue, and wherein the selecting is further based on the symptom information in the request.

4. The method of claim 1, wherein the previously collected information comprises data aggregated from the plurality of support channels regarding the computing device.

5. The method of claim 1, wherein the previously collected information comprises metadata representing previously collected diagnostic data for the computing device.

6. The method of claim 1, further comprising performing, prior to the initiating, the steps of:
determining that one or more pre-conditions for initiating the interactive support session at the entry point are unmet; and
in response to determining that one or more pre-conditions for initiating the interactive support session at the entry point are unmet, updating the entry point so that the pre-conditions are met during the interactive support session.

7. The method of claim 1, further comprising detecting that the request is originated from a specific support channel and extracting metadata from the specific support channel regarding the computing device to yield extracted metadata, and wherein the selecting is further based on the extracted metadata.

8. A system, comprising:
a processor;
a computer-readable medium having stored thereon a computer program comprising a plurality of code sections, the plurality of code sections configured for causing the processor to perform operations comprising:
receiving, from a user terminal, a request to initiate an interactive support session with the user terminal regarding a performance issue with a computing device, the interactive support session configured for providing interactive user interface elements at the user terminal for traversing a decision tree to identify at least one channel from a plurality of support channels;
obtaining, from at least one connected system, previously collected information regarding the computing device;
selecting an entry point in the decision tree based at least in part on the previously collected information; and
initiating the interactive support session with the user terminal based on the entry point.

9. The system of claim 8, the computer program further comprising code sections for causing the processor to perform operations comprising:
receiving, from the user terminal, metadata corresponding to with the performance issue for the computing device, and wherein the selecting is further based on the metadata.

10. The system of claim 8, wherein the request further comprises symptom information describing the performance issue, and wherein the selecting is further based on the symptom information in the request.

11. The system of claim 8, wherein the previously collected information comprises data aggregated from the plurality of support channels regarding the computing device.

12. The system of claim 8, wherein the previously collected information comprises metadata representing previously collected diagnostic data for the computing device.

13. The system of claim 8, the computer program further comprising code sections for causing the processor to perform, prior to the initiating, operations comprising:
determining that one or more pre-conditions for initiating the interactive support session at the entry point are unmet; and
in response to determining that one or more pre-conditions for initiating the interactive support session at the entry point are unmet, updating the entry point so that the pre-conditions are met during the interactive support session.

14. The system of claim 8, the computer program further comprising code sections for causing the processor to perform operations comprising:
detecting that the request is originated from a specific support channel and extracting metadata from the specific support channel regarding the computing device to yield extracted metadata, and wherein the selecting is further based on the extracted metadata.

15. A non-transitory computer-readable medium having stored thereon a computer program executable by a computing device, the computer program comprising a plurality of code sections for:
receiving, from a user terminal, a request to initiate an interactive support session with the user terminal regarding a performance issue with a computing device, the interactive support session configured for providing interactive user interface elements at the user terminal for traversing a decision tree to identify at least one channel from a plurality of support channels;
obtaining, from at least one connected system, previously collected information regarding the computing device;
selecting an entry point in the decision tree based at least in part on the previously collected information; and
initiating the interactive support session with the user terminal based on the entry point.

16. The non-transitory computer-readable medium of claim 15, the computer program further comprising code sections for receiving, from the user terminal, metadata corresponding to with the performance issue for the computing device, and wherein the selecting is further based on the metadata.

17. The non-transitory computer-readable medium of claim 15, wherein the request further comprises symptom information describing the performance issue, and wherein the selecting is further based on the symptom information in the request.

18. The non-transitory computer-readable medium of claim 15, wherein the previously collected information comprises data aggregated from the plurality of support channels regarding the computing device.

19. The non-transitory computer-readable medium of claim 15, wherein the previously collected information comprises metadata representing previously collected diagnostic data for the computing device.

20. The non-transitory computer-readable medium of claim 15, the computer program further comprising code sections for performing, prior to the initiating:
determining that one or more pre-conditions for initiating the interactive support session at the entry point are unmet; and
in response to determining that one or more pre-conditions for initiating the interactive support session at the entry point are unmet, updating the entry point so that the pre-conditions are met during the interactive support session.

21. The non-transitory computer-readable medium of claim 15, the computer program further comprising code sections for detecting that the request is originated from a specific support channel and extracting metadata from the specific support channel regarding the computing device to yield extracted metadata, and wherein the selecting is further based on the extracted metadata.
